(19) United States
(12) Patent Application Publication
(10) Pub. No.: US 2007/0226314 A1
(43) Pub. Date: Sep. 27, 2007

(54) SERVER-BASED SYSTEMS AND METHODS FOR ENABLING INTERACTIVE, COLLABORTIVE THIN- AND NO-CLIENT IMAGE-BASED APPLICATIONS

(75) Inventors: Stephen G. Eick, Naperville, IL (US); M. Andrew Eick, Farmington Hills, MI (US); Jesse A. Fugitt, Naperville, IL (US); Andrea Hundt, Chicago, IL (US); Brian Horst, Naperville, IL (US); Maxim Khailo, Downers Grove, IL (US); Phillip Paris, Chicago, IL (US); Kurt Rivard, Naperville, IL (US); Russell Lankenau, Naperville, IL (US)

Correspondence Address: LATHROP & CLARK LLP, 740 REGENT STREET SUITE 400, P.O. BOX 1507, MADISON, WI, 537011507, US

(73) Assignee: SSS Research Inc., Naperville, IL (US)

(21) Appl. No.: 11/688,132

(22) Filed: Mar. 19, 2007

Related U.S. Application Data
(60) Provisional application No. 60/784,700, filed on Mar. 22, 2006.
(60) Provisional application No. 60/865,786, filed on Nov. 14, 2006.

(51) Int. Cl. G06F 15/16; G06F 15/173

(52) U.S. Cl. 709/217; 709/203; 709/223

(57) ABSTRACT

A server receives image, graphic and/or analytic data and processes and asynchronously outputs that data to a thin/no client. The server inputs image data in a variety of different formats and renders a normalized format that can be streamed to the thin/no client using light-weight protocol(s). The server updates the image, feature and/or analytic data in real time. The server inputs feature, analytic, business logic and other data and process it into various format(s) that can be streamed to the thin/no client and overlaid on the image data. The server provides application services, which can include collaboration, tracking, alerting, business, workflow and/or other desired services. The server can receive collaboration data from one thin/no client and stream that collaboration data to other thin/no clients to enable shared situational awareness between the thin/no clients. The server includes a programming environment for programming thin/no clients contained within server-based web pages.

### IMAGE-BASED APPLICATIONS

This application claims priority to U.S. Provisional Patent applications 60/784,700, filed Mar. 22, 2006 and 60/865,786, filed Nov. 14, 2006, each of which is incorporated herein by reference in its entirety.

### BACKGROUND OF THE INVENTION

1. Field of the Invention

This invention is directed to systems and methods that enable interactive, collaborative thin-/and no-client applications that allow a user to manipulate images and spatially-based data.

2. Related Art

Traditional microprocessor-based computer software is based on a fat-client model, where a copy of the software is physically installed into the memory of the computing device. The installed software is run by accessing the location on the memory where the software is stored, such as a specific folder within a specific non-volatile memory device, such as a hard drive. In a windows-based operating system, each fat-client software application is launched and executed in a separate window. The user interface of the fat-client software application allows the user to interact with the rest of the software application. The fat-client software application loads any data it needs from the local hard drive of the computing device.

Users' expectations about software applications have increased along with the increasing computing power of the state-of-the-art microprocessors and with the increasing sophistication of state-of-the-art computer graphics. As a consequence, the size and complexity of software applications have increased dramatically. As a result, state-of-the-art fat-client software applications require ever-increasing amounts of storage space. Similarly, as a result, such fat-client software applications need ever-increasing numbers of software entities, such as dynamic link libraries, to access the functionality of the operating system software and other software applications.

Although the user interface of such fat-client software application is often very rich, such fat-client software applications have numerous drawbacks. Often, the data used by the fat-client software application is in a proprietary, closed format. This makes it difficult, if not impossible, for the fat-client software application to access, or ingest, different types of data without providing specific application programming interfaces (APIs) to support those different data formats. Similarly, such proprietary formats make it difficult, if not impossible, for such a fat-client software application to work with other applications without providing specific APIs to support that functionality. Likewise, due to their size and complexity, it has become increasingly difficult to install, maintain, update, upgrade and properly uninstall such fat-client software applications. Deploying updates, upgrades and the like for such fat-client applications typically now requires an additional install process.

A browser-based web application avoids several of the problems associated with a fat-client software application. Since a web application is stored on a web server and launched by browsing to a specific URL using a web browser, the entire application deployment process is greatly simplified. Upgrading the web application is also easier than upgrading a fat-client software application. For example, if the web application has been upgraded since the last time the user used the web application, as the user will automatically get access to the upgraded web application when the user browses to that web application's URL. Similarly, updated data can be retrieved from a local hard drive as with a fat client application or it can be retrieved by requesting it from remote URLs on other networks.

Web applications also often need to be able to ingest data from different sources, such that the need for data standards in web applications has become obvious. Groups such as the Open Geospatial Consortium (OGC) have defined geospatial-data-related standards that many web applications implement. Another important difference between fat-client software applications and web applications is that extending a web application's functionality is often much easier than extending the functionality of a similar fat client software application. The server architecture of a web application can be designed in such a way that it supports a plug-in based approach, so that individual pieces of functionality can be easily added or removed.

Traditional web applications, which are known in the art as Web 1.0 applications, are designed using a client-server model. When a user clicks on a link, the web browser, i.e., the client, issues an http request to a server for a new page whose URL is associated with the activated link. The web server, which is usually implemented using Apache or IIS server software, performs some processing on the http request, retrieves information from one or more legacy systems, performs some data processing, and sends a formatted page of HTML code back to the client, i.e., the web browser, which displays the formatted page of HTML code to the user. This approach is the simplest technically, but does not make much sense from the user's perspective. This is due to the latency inherent in the client-server model, which can be from one to ten seconds between the time when the user requests the page and the time when the requested page finally loads and is displayed to the user. Because of this latency, it is not possible to use “direct manipulation” user interfaces.

### SUMMARY OF DISCLOSED EMBODIMENTS

It has long been known that direct manipulation user interfaces are greatly preferred by users. A set of technologies that are broadly called Web 2.0 provides a new model and eliminates the start-stop-start-stop nature of web applications. In this new model, information is asynchronously downloaded to the browser using XML. JavaScript code running in the browser caches this information when it is received from the server and displays it upon user request. Since the information is cached locally, the web application can provide instantaneous responses and thereby support direct manipulation operations. JavaScript code in the browser handles user interface interactions, such as panning, zooming, scaling, and data validation. Using asynchronous requests for XML data allows users to continue working with the responsive user interface of the web application without losing the user's focus on the screen while the data is downloading.

However, even with conventional Web 2.0 technologies that are currently available, information can only be accessed using such web applications by clicking on hyperlinked objects within the displayed web page to create new requests sent from the client-side browser software to the server. As a result, conventionally, while it is possible to display visual information, the user's ability manipulate to the displayed information, even using current Web 2.0 technologies, is extremely limited, if enabled at all. Moreover, the visual information tends to be “static”, at least with respect to the displayed web page. That is, any animation or video, while not truly “static”, is fixed relative to a particular web page upon that web page being downloaded. Thus, while the video or animation file may provide some dynamic display of information, the video or animation file itself is static and fixed with respect to a particular web page. As a consequence, it is not possible to dynamically alter the content of the downloaded file without generating a new request to the server, as in the Web 1.0 case.

Even websites that give the appearance of true asynchronous communication between the client-side browser and the server-side web site, such as Google® Maps™ and the like, actually only generate new requests for data upon the user interacting with the various control elements on the page, such as by clicking the zoom control, by using the mouse to grab and pan the map and/or the like.

True asynchronous data exchanges between the client-side browser software and the server-side web site would be highly desirable. However, this has heretofore not been possible, as AJAX (asynchronous Java script and XML) techniques and technologies are not widely understood and document object model (DOM) programming is very difficult.

U.S. Provisional Patent Application 60/784,700 to Eick et al., which is incorporated herein by reference in its entirety, discloses a novel thin-client or no-client software application architecture. This thin or no client application allows a user to access, using a browser, a web page that includes a thin or no client software application. When that web page is returned in response to an http request, the thin or no client application executes within the browser and allows the user to interact with the thin or no client application using a rich application interface.

In various exemplary embodiments, the user inputs an address of a thin or no client application web location into the address widget of the browser's user interface. In response, the accessed location returns the desired web page to the user's browser, which executes the AJAX code contained within the accessed web page. The thin or no client application disclosed in the incorporated 700 Provisional Patent Application pulls static image data, such as raster data, and graphic image data, such as scalable vector graphics (SVG), from the server as the user pans, zooms or otherwise alters the information displayed in the browser window using the thin or no client application.

Humans are visually-oriented beings who are most easily able to understand, assimilate, and interact with information when it is presented visually, as images. Typical examples of such images are maps and other types of geospatial or spatial images, such as floor plans, and other types of drawings that represent locations, whether of real or virtual places and/or things, and even data visualizations and other pure images, where “locations” within the image, i.e. the x-y pixel position, often need to be referenced.

However, there are many factors which make it especially difficult to provide thin or no client applications that allow users to interactively and collaboratively manipulate images. These factors include the larger size of a typical image, and that the images are stored natively in a wide variety of differing and often incompatible formats.

The inventors have discovered that, to provide a thin or no client image-based application having a rich interactive interface, the thin or no client image-based application needs more server support than do corresponding fat client applications installed and operating on full desktop systems, Web 1.0 applications or conventional Web 2.0 applications.

This invention provides server-based systems and methods for streaming image-based data to a thin or no client application.

This invention separately provides systems and methods for processing and streaming image-based data from a server to a thin or no client application.

This invention separately provides systems and methods for processing image-based data at a server and streaming the processed data to a thin or no client application using a simple protocol.

This invention separately provides systems and methods for processing image-based data at a server and streaming the processed data to a thin or no client application using a lightweight protocol.

This invention separately provides systems and methods for asynchronously streaming image-based data from a server to a thin or no client application.

This invention separately provides systems and methods for receiving image-based data from one device running a thin or no client application and for streaming that received image based-data to a number of other devices running that thin or no client application.

This invention separately provides systems and methods that enable shared situational awareness between a number of users using devices running a thin or no client application.

This invention separately provides systems and methods that enable collaboration between users of a thin or no client application.

This invention separately provides systems and methods that update the image data displayed to a user of an image-based thin or no client application in real time.

This invention separately provides systems and methods that enable code wrapping of JavaScript.

This invention separately provides systems and methods that combine image data, feature data and/or analytic data.

This invention separately provides systems and methods for accessing, image, graphic and analytic data to be asynchronously streamed to a thin or no client application.

This invention separately provides systems and methods for processing image, graphic and analytic data to be asynchronously streamed to a thin or no client application.

This invention separately provides systems and methods for organizing and storing image, graphic and analytic data to be asynchronously streamed to a thin or no client application.

This invention separately provides systems and methods for programming thin or no client applications contained within server-based web pages.

Various exemplary embodiments of systems and methods according to this invention include a server that receives image data, graphic data and/or analytic data and that processes and asynchronously outputs the processed image data, graphic data and/or analytic data to a thin or no client application. In various exemplary embodiments, the thin client application is stored in a web page stored on the server. In various exemplary embodiments, a user uses a client-side browser to access and download the web page containing the thin or no client application from the server. The browser executes the software code elements of the thin client application contained in the accessed web page, which causes the browser to display a thin client interface according to this invention. In various exemplary embodiments, systems and methods according to this invention provide a direct manipulation interface in a web-based application.

In various exemplary embodiments, the thin or no client application is usable to display an image-based framework. In various exemplary embodiments, systems and methods according to this invention allow various application services to be overlaid on top of the displayed image-based framework. In various exemplary embodiments, these services can include one or more of collaboration services, tracking services, business and/or workflow services and/or other desired services.

In various exemplary embodiments, server-based systems and methods according to this invention can input image data in a variety of different formats and process the image data to place it into a single format that can be easily streamed to the thin or no client application. In various exemplary embodiments, the single format is a standard format or a non-proprietary format. In various exemplary embodiments, the data is streamed to the thin or no client application using one or more simple or light-weight protocols. In various exemplary embodiments, the protocols can include standard protocols and/or non-proprietary protocols.

In various exemplary embodiments, server-based systems and methods according to this invention can input feature data and other graphics-based data, analytic data, business data and the like and process that data into one or more formats that can be easily streamed to the thin or no client application and overlaid on the image data that has been streamed to that thin or no client application. In various exemplary embodiments, the feature and other graphics-based data, analytic data, business data and the like can be rendered by server-based systems and methods into image data that can be streamed to the thin or no client application and overlaid on to other streams of other image data. In various other exemplary embodiments, the feature and other graphics-based data, analytic data, business data and the like can be converted to objects that are renderable by the thin or no client application or its run-time environment. In various exemplary embodiments, these objects are streamed to the thin or no client application, where they are rendered and overlaid on top of the streamed image data.

In various exemplary embodiments, server-based collaboration services receive streams of feature and other graphics-based data, analytic data, business data and the like from the thin or no client application. The collaboration services republish the received data to other instances of that thin or no client application, which are able to input and display that republished data at the appropriate location on the displayed image data.

In various exemplary embodiments, server-based tracking services receive streams of tracking data from a GPS-based tracking system, an RFID-tag-based tracking system or any other known or later-developed devices and/or systems that generate tracking data. Accordingly, while the following detailed description of exemplary systems and methods according to this invention may refer to GPS data or devices and/or RFID data and/or devices, it should be appreciated that such references are for ease of understanding only, and are not intended to limit systems and methods according to this invention to GPS or RFID data or devices. In various exemplary embodiments, this tracking data typically includes location or position data of a GPS receiver, an RFID tag or a similar device whose location relative to some map or location image can be sensed or determined, such as a floor plan or the like, as well as time data indicating when that GPS receiver or RFID tag was at the determined position. In various exemplary embodiments, the tracking services renders the position and/or time data into either an image data stream or feature data stream that is output to the thin or no client application. The image or feature data stream can be overlaid over the appropriate image data representing the general location of the GPS receiver or RFID tag, so that the actual track of a person or thing associated with that GPS receiver or RFID tag can be seen.

In various exemplary embodiments, server-based analytic services can be combined with the tracking data and/or services and/or collaboration services to provide various types of alerts, planning and the like. For example, analytic services can be combined with the tracking data to determine if the person or thing associated with a particular GPS receiver, RFID tag or the like has violated a business rule, such as going off-route, going into a restricted area or the like. Similarly, other analytic services can be combined with the tracking data or services and/or the collaboration services to plan search routes, plan rescue or recovery operations for persons or assets located by a searcher based on the tracked location of the searcher and collaborative data received from the searcher, or the like.

In various exemplary embodiments of systems and methods according to this invention, the thin or no client application provides a rich thin or no client interface that provides interactive image and/or graphical elements. In various exemplary embodiments, as the user interacts with the thin or no client interface, the thin or no client application asynchronously generates and sends data requests to the server and/or returns collaboration data from the user to the server. In various exemplary embodiments, in response to the data requests, the server accesses additional and/or updated image data, graphic data and/or analytic data and sends that data to the thin or no client application. In various exemplary embodiments, the server receives the collaboration data from the thin or no client application and makes that collaboration data available to other instances of the thin or no client application.

These and other features and advantages of various exemplary embodiments of systems and methods according to this invention are described in, or are apparent from, the following detailed descriptions of various exemplary embodiments of systems and methods according to this invention.

### BRIEF DESCRIPTION OF DRAWINGS

Various exemplary embodiments of systems and methods according to this invention will be described in detail, with reference to the following figures, wherein:

FIG. 1 illustrates one exemplary embodiment of a thin or no client application according to this invention;

FIG. 2 is a block diagram outlining a first exemplary embodiment of a server system that supplies one or more asynchronously accessed data streams to the thin or no client application shown in FIG. 1;

FIG. 3 illustrates an image that comprises a plurality of image tiles;

FIG. 4 is a block diagram showing in greater detail one exemplary embodiment of the map services portion of the server system shown in FIG. 2;

FIG. 5 is a functional block diagram outlining one exemplary embodiment of the flow of data into, within and out of the map services portion shown in FIG. 4;

FIG. 6 is a block diagram of one exemplary embodiment of the data structure of a preprocessed image archive;

FIG. 7 is a block diagram outlining a second exemplary embodiment of a server system that supplies one or more asynchronously accessed data streams to the thin or no client application shown in FIG. 1;

FIGS. 8 and 9 show fragments of html code for a thin or no client application according to this invention illustrating one exemplary embodiment of extended html tags according to this invention that can be converted using the second exemplary embodiment of the server system shown in FIG. 7 into AJAX code executable by the runtime environment that the thin or no client application will run under;

FIG. 10 shows a fragment of AJAX code generate using the second exemplary embodiment of the server system shown in FIG. 7 from extended html tags according to this invention;

FIG. 11 is a block diagram outlining one exemplary embodiment of the conversion of the html code shown in FIG. 8 in to the AJAX code shown in FIG. 10;

FIG. 12 illustrates how corresponding tiles of two different data sources that have been processed by a server system according to this invention can be overlaid by a thin or no client application according to this invention;

FIG. 13 illustrates one exemplary embodiment of a server-side object model implemented as a set of XHTML tags according to this invention;

FIG. 14 illustrates one exemplary embodiment of a hierarchy of the set of XHTML tags shown in FIG. 13;

FIG. 15 illustrates one exemplary embodiment of a number of tiles of image data overlaid with a number of graphic elements representing various objects' position history data;

FIG. 16 illustrates one exemplary embodiment of a heat map;

FIG. 17 illustrates one exemplary embodiment of a number of tiles of image data overlaid with a number of graphic elements representing various objects' location data and area of influence or coverage data;

FIGS. 18 and 19 illustrate a pair of exemplary embodiments of a number of tiles of image data overlaid with a number of graphic elements position tracking of objects relative to defined hot spots; and

FIG. 20 illustrates a thin or no client application that allows a user to create and send collaboration data back to the server system.

### DETAILED DESCRIPTION OF EXEMPLARY EMBODIMENTS

“Web 1.0” is the term associated with the first generation of internet browser applications and programs, along with the associated client-side software entities and server-side software entities used to support and access information using the Internet. Such Web 1.0 technologies, like most first-generation technologies, are geared more to enabling a workable system and to the capabilities of the available software and hardware platforms, rather than to creating a rich and efficient experience for the system's users. Thus, conventional Web 1.0 technologies, while efficient for machines, are often highly inefficient and frustrating for their human users.

In particular, Web 1.0 technologies operate on a “click-wait” or a “start-stop” philosophy. That is, when a user wishes to view a web page, the user must generate a request using the client-side browser software, and send that request to the server. The user must then wait for the server to respond to the request and forward the requested data. The user must further wait for all of the requested data to be received by the client-side browser software and for the browser software to parse and display all of the requested information before the user is allowed to interact with the requested web page.

This is frustrating for most users on a number of levels. First, for slow or bandwidth-limited Internet connections, obtaining all of the requested data can often take a relatively long time. Furthermore, even when the user has high-speed access to the Internet, a web page that requires data to be re-loaded or refreshed on a fairly regular basis, such as mapping web pages and other image manipulation web pages, sporting events scores, or play-by-play web pages and the like, can cause significant delays. This is typically due to Web 1.0 requirements that the entire web page be retransmitted even if no or only minimal changes have occurred to the displayed information.

Accordingly, the next generation of technologies used to access and support the Internet are currently being developed and collected under the rubric “Web 2.0”. A key feature in the “Web 2.0 ” concept is to eliminate the above-outlined “click-wait” or “start-stop” cycle, by asynchronously supplying data associated with a particular web page to the user from the associated web server. The transfer occurs as a background process, while a user is still viewing and possibly interacting with the web page. In some such Web 2.0 web applications, the web application anticipates that the user will wish to access that asynchronously-supplied data. A number of important technologies within the “Web 2.0 ” concept have already been developed. These include AJAX, SVG, and the like.

AJAX (Asynchronous JavaScript and XML) is a web development technique useable to create interactive web applications. AJAX is used to make web pages feel more responsive, by exchanging small amounts of data between the web application and the server supporting that web application as a background process. Accordingly, by using AJAX, an entire web page does not have to be re-loaded each time a portion of the page needs to be refreshed or the user makes a change to the web page at the client side. AJAX is used to increase the web page's interactivity, speed, and usability. AJAX itself makes use of a number of available techniques and technologies, including XHTML (extended hyper-text markup language) and CSS (cascading style sheets), which are used to define web pages and provide markup and styling information for the web pages. It also makes use of a client-side scripting language, such as JavaScript, that allows the DOM (document object model) to be accessed and manipulated, so that the information in the web page can be dynamically displayed and can be interacted with by the user.

Other important technologies include web feeds, such as RSS (really simple syndication, rich site summary or RDF site summary), and ATOM, the XMLHttpRequest object, which is used to exchange data asynchronously between the client-side browser software and the server supporting the web page being displayed, and XML and other data exchange standards, which are used as the format for transferring data from the server to the client-side browser application. Finally, SVG (scalable vector graphics) is used to define the graphical elements of the web page to be displayed using the client-side browser application.

As indicated above, traditional web applications work on a client-server model. The client, which is typically a web browser, issues a request to a server for a new page when the user clicks on, or otherwise activates, a hyperlink. The web server, which is usually Apache or IIS, does some data processing on the received request, retrieves information from various data source systems, does some additional data processing, and transmits a formatted page of hypertext back to the requesting client. In response, the requesting client receives the transmitted formatted page of hypertext, parses and renders it, and displays it to the user.

In particular, such conventional client-server software architectures rely on heavy, complex protocols. Clients that implement these protocols use a large number of data points and require a large amount of data. Often, the protocols implemented in such conventional client-server software architectures are proprietary, and use fixed length packet sizes. While such conventional client-server software architectures are common, they require clients with substantial processing power.

While this approach is simple technologically, it does not make much sense from the user's perspective. As indicated above, the reason for this is the inherent latency in this system between the time when the user requests a page and the time when the page is finally loaded. This latency can typically be as high as ten seconds. Because of this latency, it is not possible to use direct manipulation user interfaces, as defined in “Readings in Information Visualization: Using Vision to Think,” S. Card et al., Morgan Kaufman, 1999, incorporated herein by reference in its entirety. However, as discussed in “Designing the User Interface,” B. Schneiderman, Addison Wesley, 3rd Edition, 1998, incorporated herein by reference in its entirety, this class of user interfaces is greatly preferred by users.

As indicated above, the set of technologies known as Web 2.0 enables a new model that eliminates the start-stop-start-stop nature of traditional web applications. Rather, using these technologies, information is asynchronously requested and returned to the requesting browser using XML. JavaScript code in the browser parses and stores this information as it is received from the web server. This stored information can be displayed automatically or upon user request. Since the asynchronously-provided information is cached locally, the browser running such JavaScript code can provide instantaneous responses to user inputs and thereby support direct manipulation operations. Typically, JavaScript code in the browser handles interactions such as panning, zooming, scaling, and data validation. Such asynchronous requests for XML data are advantageous in that users can continue working with the web page displayed in the browser window without losing their focus and waiting while data is downloading.

SVG is a World Wide Web Consortium (W3C) XML standard for two-dimensional, browser-based graphics. Using Web 2.0 programming techniques and SVG, a generic graphical user interface as disclosed in the incorporated 700 Provisional Patent Application incorporates an interactive set of lightweight, browser-based visual components. Graphical user interfaces as disclosed in the incorporated 700 Provisional Patent Application provide a rich desktop user experience and include many of the features found in Windows®-based client-side applications. In various exemplary embodiments, web applications according to this invention are implemented using a thin or no client platform that is portable to mobile devices. Thus, using the interactive set of lightweight, visual components as disclosed in the incorporated 700 Provisional Patent Application, it is possible to develop interactive, web-based data visualizations that are browser-based and able to run in a typical standard browser or on a later-developed browser. As indicated above, this interactive set of lightweight, browser-based visual components does not require installing any additional client-side software, such as applets, active-x controls dynamic link libraries (DLLs) or client-side interpreters like the Java Virtual Machine (JVM).

It should be appreciated that, at present, the term “thin client” generally refers to some type of applet, active-x control or other software entity that executes in a browser or other run-time environment. In contrast, for browser-based systems, such as desk-top computers and the like, web applications enabled by server systems and methods according to this invention do not require any applets, active-x controls or other software entities, and thus can be referred to as a no-client application. For devices that use the Windows Mobile operating system and similar environments or mobile devices, web applications entitled by server systems and methods according to this invention may require such software entities and thus may be thin-client applications.

In contrast, in various exemplary embodiments of systems and methods according to this invention, client-server software architectures according to this invention use light, variable non-proprietary protocols that allow the clients and servers to leverage what each side does well to reduce, and ideally minimize the amount of processing that the client is required to perform, i.e., minimize the amount of things that the client has to do. In various exemplary embodiments, client-server software architectures according to this invention attempt to balance the amount and types of processing that is done at the server side and the amount and types of processing that is done at the client side. In various exemplary embodiments, the amount and types of processing done on the client side is based on the client side's capabilities.

For example, in various exemplary embodiments, if the client is able to render SVG data streams and objects and overlay such objects onto raster image data, then the server will supply feature data as an SVG data stream. However, if the client is not able to render SVG data streams and objects, the server renders the SVG data stream into raster data tiles, which are then forwarded to the client. Because the data supplied to the client can be based on the capabilities of the client, and the client's capabilities can vary depending on the capabilities of the underlying computer system the client is executing on, the processing can be divided efficiently between the server side and the client side.

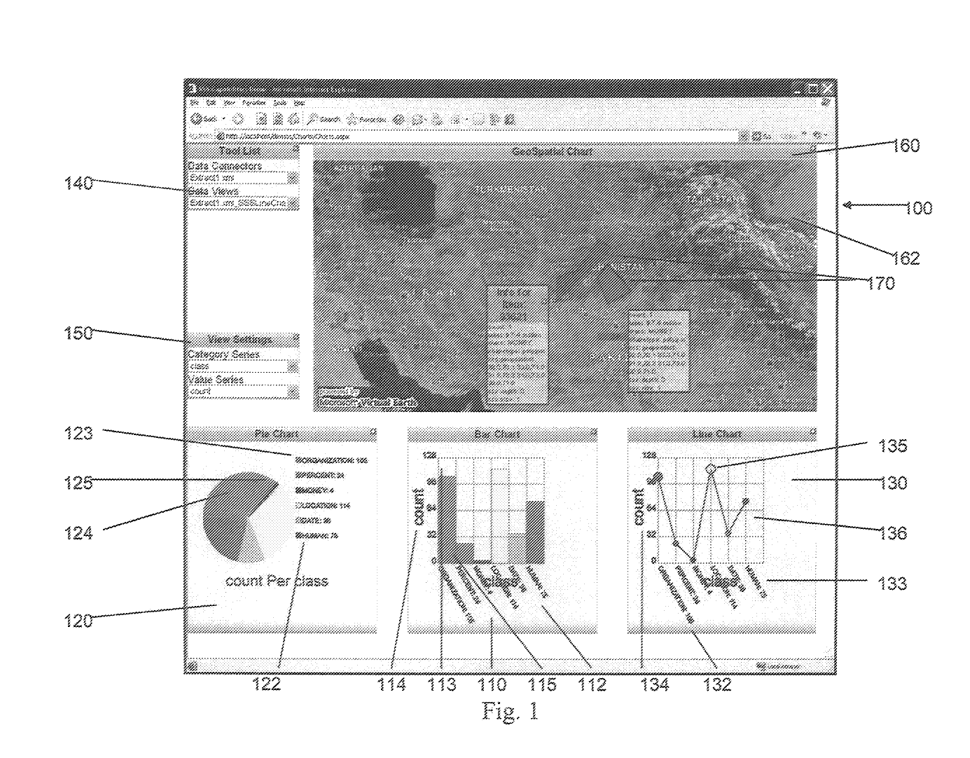

FIG. 1 shows one exemplary embodiment of a thin or no client application that includes a plurality of visual components. In particular, the thin or no client application 100 shown in FIG. 1 includes a bar chart view 110, a pie chart view 120, a line chart view 130, a Tool List widget 140, a View Settings widget 150 and a geospatial data/information view 160.

As shown in FIG. 1, the bar chart view 110 includes a plurality of data item classes 112 associated with the columns 113 of the bar chart view 110 and a value axis 114 that indicates the data values associated with the various points along the columns 113. In the bar chart view 110, each of the columns 113 includes a plurality of data items 115 that are color-coded corresponding to the particular column in which they appear. Each of the data items 115 is selectable.

The pie chart view 120 includes a color-coded legend 122 that indicates the various data classes 123 and the color codes used in the pie chart 124 associated with each of those data classes 123. For example, the organization class 123 is associated with a portion of the pie chart 125 and is colored using the color code associated with the organization class 123.

The line chart view 130 includes a legend 132 that indicates the various data classes 133. Each data class 133 has an icon 135 that is plotted along the value axis 124 in a column 136 associated with that data class 133. Each icon 135 is size coded based on the value of the associated data class and is color coded using the color codes used in the pie chart 124 associated with each of the corresponding data classes 123 and used for the data items 115 associated with each of the corresponding data item classes 112 in the bar chart view 110. For example, icon 135 for the organization class 133 has the same color as the portion of the pie chart 125 and the organization class 113.

The Tool List widget 140 allows the user to dynamically select the different data connectors/collections and the corresponding views associated with that data. By selecting a specific view, like the line chart, the user can use the View Settings widget 150 to manipulate the different axes for that chart. The x axis could be changed from “class” to “label” so that the bar chart would represent “count” per “label” in each bar instead of “count” per “class”. When these tools are used to manipulate the views, the page is not refreshed because the views are able to dynamically redraw themselves.

The image view 160 displays various types of image information, including satellite images, such as that shown in FIG. 1, map data, hybrid map/satellite data, or other image data representing a location or where a location in the image has meaning. The image view 160 displays an image 162, which in this exemplary embodiment is a satellite image, and a plurality of data icons 170. In various exemplary embodiments, the image view 160 comprises two or more independent layers of information, including, for example, an image layer and one or more rendered objects layers. In various exemplary embodiments, the image layer includes one or more static images, such as JPEG images, GIF images, bit-map images and/or the like. It should be appreciated that, while the image view 160 is also referred to as a geospatial chart view, any image can be displayed in the image view 160. The image view 160 is particularly useful to associate data items with specific locations within the image displayed within the image view 160. For example, the image can be a medical image, such as an X-ray, a CAT scan, an MRI scan or the like, where the associated data items are simple graphical elements, such as a circle, and text boxes that a first user has added to the image in a collaboration mode to highlight a medically relevant area of the image that the first user wishes to bring to the attention of other, remotely-located, users that are collaborating with the first user. Similarly, the image can be a current image of a work of art that is being restored, where the associated data items include data about specific locations within the work of art that need to be shared between the restorers.

In the exemplary embodiment shown in FIG. 1, the satellite image 162 is displayed in the image layer and is typically a JPEG or GIF image supplied by some web-based mapping service. Microsoft®'s Virtual Earth™ or Google® Maps™ are two well-known sources of such geospatial image data. However, it should be appreciated that any known or later-developed geospatial image source can be used to obtain the satellite image 162 shown in FIG. 1. In various exemplary embodiments, the various data icons 170 are implemented in one or more rendered objects layer and are implemented as independent graphic objects overlaid on the satellite image 162.

It should also be appreciated that, in various exemplary embodiments, the user can arbitrarily zoom in and out on the satellite image 162. In various exemplary embodiments, the zoom function is linked to the scroll wheel of the mouse. Accordingly, when the mouse is within the image view 160, and the user rotates the mouse scroll wheel, the user can zoom in or out of the image. In various exemplary embodiments, a plurality of different zoom levels can be provided. For example, for geospatial data, the zoom levels can range from a world level to a meter level.

Scalable Vector Graphics is an XML markup language for vector graphics. Using SVG or some other object rendering language, it is possible to build both static and animated graphical displays in browsers. SVG is an open standard created by the W3C (World Wide Web Consortium). Nearly all browsers now provide native support for SVG or provide support through a browser plug-in. SVG also appears to be the graphics standard of choice for cell phones and mobile devices. Microsoft is developing a competing XML-based language, called XAML, that is usable to create user interfaces. Although the above and following descriptions often refer specifically to SVG, it should be appreciated that systems and methods according to this invention generally work equally well with either SVG, XAML or any other known or later-developed object rendering language. By abstracting the graphics layer, it is possible to produce interactive components based on whatever rendering language the particular display device or system supports. By providing the user with a responsive user interface, the ability to create Rich Internet Applications is truly possible.

In various exemplary embodiments, the thin or no client application 100 can be implemented as a thin or no client application 100 using a Web 2.0 AJAX client and development environment, such as that disclosed in the incorporated 700 Provisional Patent Application. The incorporated 700 Provisional Patent Application discloses a set of visual components usable to build web-based graphical applications. Using a common data infrastructure, these components ingest image and RSS data and provide visualization and collaboration services. To make these components easier to use for non-programmers, this Web 2.0 AJAX client and development environment provides JSP and ASPX tags that enable the visual components to be readily used on web sites.

The incorporated 700 Provisional Patent Application discloses an AJAX/SVG visualization framework usable to build thin or no client applications. As disclosed herein and in the incorporated 700 Provisional Patent Application in various exemplary embodiments, a JavaScript framework usable to build reusable visualization components uses the Scalable Vector Graphics browser API. This graphics API is a W3C standard that is natively supported by many browsers.

It should be appreciated that the JavaScript framework disclosed herein and in the incorporated 700 Provisional Patent Application provides a broad set of visual components that includes maps, business charts, networks and graphs, trees and hierarchical displays, such as those shown in FIG. 1. Each of these components has been developed using this JavaScript framework. When wrapped with the appropriate HTML code, each of these components may be independently positioned and moved on the browser screen.

Each of the visual components of the thin or no client application 100, such as the various views 110, 120, 130 and 160, ingests data to be displayed based upon asynchronous web feeds, such as, for example, RSS and namespace extensions of RSS, that provide these visual components with specialized information. As outlined above, RSS is a simple protocol for publishing information. The basic content of an RSS feed or stream is a set of metadata tags organized into items that describe content. The RSS protocol organizes information into sets of items within a channel. In the RSS protocol, the required tags in each item are <title>, <link>, <description>, <pubDate>, <guid>. The <link> tag is generally a hyperlink to retrieve the item content.

The visual components of the thin or no client web application disclosed in the incorporated 700 Provisional Patent Application and disclosed herein are able to ingest RSS feeds or streams and are able to display the received information using different views. The image view 160, for example, is able to display GeoRSS feeds. GeoRSS, which is a standard extension of the base RSS protocol, geo-positions entities in the browser over a map. As disclosed in at least the incorporated 700 Provisional Patent Application, “Tooltips” and other mouse operations on particular item set(s) displayed in one view or visual component are automatically linked among different views or visual components that display those particular item set(s). This approach towards view or visual components makes it easy to create rich visual applications.

Rendering 2D vector graphics in a web browser is challenging for many reasons. Lack of IDE support for JavaScript makes it difficult to debug and step through the JavaScript code needed to render vector graphics that manipulate the browser's document object model (DOM). In addition, cross-browser coding is even more difficult because not all browsers support the same type of vector graphics. Currently, the latest browser releases of Mozilla Firefox, Opera, and Safari all have native support for SVG. However, Microsoft Internet Explorer only provides native support for VML (vector markup language), which is a similar vector graphics library designed by Microsoft. By using a plug-in, Microsoft Internet Explorer can also support SVG documents that are included through the use of an “embed” or “object” tag. The varying state of vector graphics capability between common browsers introduces substantial complexity for the typical web developer who typically just needs to do simple things, such as, for example, drawing points, circles, rectangles, or other polygons.

It should be appreciated, as outlined above, that any type of image may be displayed in the image layer(s). Many types of image data, such as, for example, maps, satellite and other geospatial images, and the like inherently have a location component that corresponds to a physical location. Other types of images that include such inherent location components include building floor plans, structures, and the like. Still other types of images do not have inherent physical locations. Some such images are images of physical objects, where the physical location is defined relative to the object itself. Examples of such images are images of large objects, such as planes, ships and the like, images of a body of an animal or human and the like. Other images have location data that is referenced only to a point within the image itself, such as a virtual or fictional image. It should be appreciated that, as long as there is some way to relate a portion of an image to some type of location data, whether extrinsic to the image or intrinsic to the image, the image can be used with various systems and methods according to this invention.

It should be appreciated that, in various exemplary embodiments, the JavaScript tags according to this invention are hierarchically related and implement a special version of JavaScript. This tags are easy for JavaScript to consume and are designed such that they are independent of the operating system implemented on the server. That is, for example, regardless of whether the server is running within a Windows IIS environment or within a Linux Apache environment, the same tags are used, such that the same tags exist between Java and Microsoft. It should be appreciated that these tags work in concert with JavaScript and that they emit a structure that JavaScript expects. In other words, these tags are not generalized. Therefore, JavaScript can be tuned to work with these tags. This further allows for efficient staging of the client.

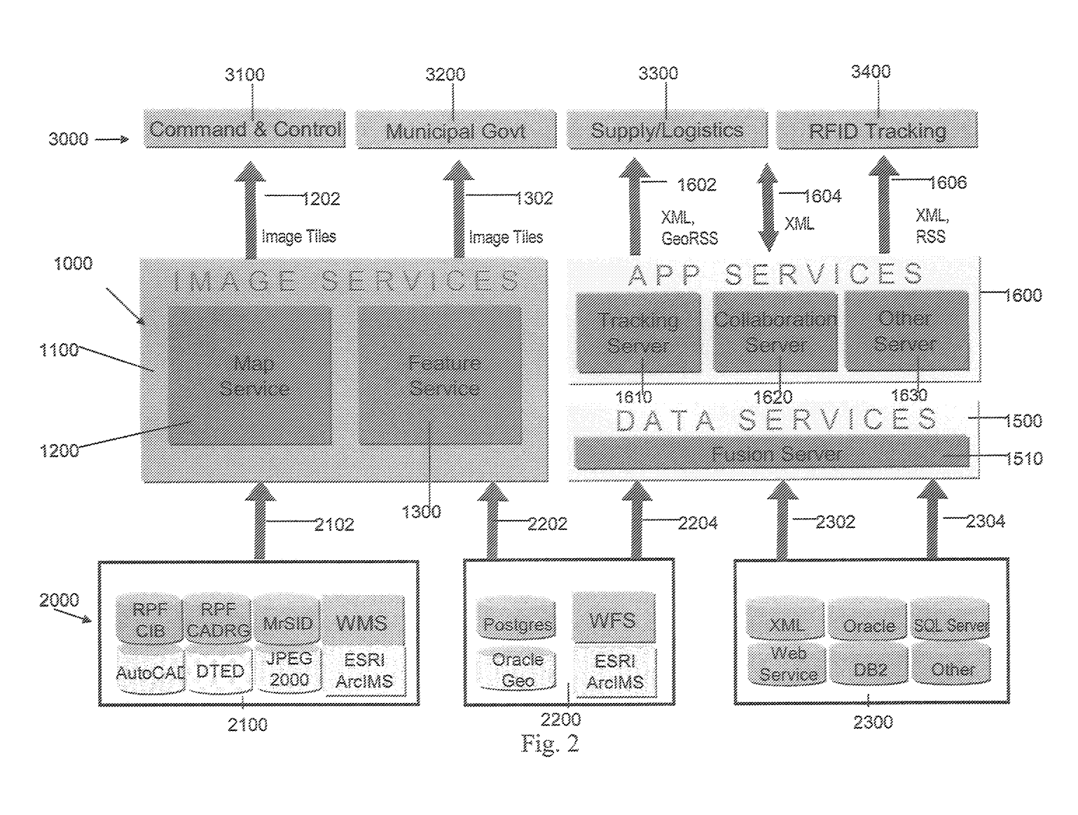

FIG. 2 is a block diagram outlining a first exemplary embodiment of a server system 1000 that supplies one or more asynchronously accessible data streams to a thin or no client application, such as the thin or no client application 100 shown in FIG. 1. In the exemplary embodiment shown in FIG. 2, the server system 1000 uses a multi-tier architecture. In this exemplary embodiment, the server system 1000 ingests raster image data, feature image data, and non-image business and other analytical, numerical and/or text data from a wide variety of data sources, such as the set of image repositories or data sources 2100, the set of feature data repositories or data sources 2200 and other data repositories 2300. These other data repositories can store other types of data, such as business data, analytical data, numerical data and/or text data, instead of or in addition to, image and/or feature data. The server system 1000 then transform the ingested data into formats and protocols that the thin or no client application 100 shown in FIG. 1 can accept, such as, for example, image tiles, XML, RSS or other known or later developed data feeds or the like, and performs database and other services for the thin or no client application 100.

As shown in FIG. 2, in various exemplary embodiments, the server system 1000 includes image services 1100, data services 1500 and application services 1600. The image services 1100 is used to stream image tiles 1110, comprising image tiles 1202 and/or feature tiles 1302, to the thin or no client application 100. The image tiles 1202 can be obtained from one or more of the set of image repositories 2100 over a link 2102 using the map services 1200. Alternatively, the feature tiles 1302 can be created by using the feature services 1300 to render feature data 2200, input over the link 2202, into the feature tiles 1302.

As shown in FIG. 2, in various exemplary embodiments, the data services 1500 includes a fusion server 1510. The data services 1500 ingests both feature data from the set of feature data repositories 2200 over a link 2204 and business, numerical and/or text data from a third set of data repositories 2300 over one or more links 2302 and 2304. The operation of the data services 1500, including the fusion server 1510, is outlined in greater detail below.

As also shown in FIG. 2, the application services 1600 comprises a tracking server 1610, a collaboration server 1620 and possibly one or more other servers 1630 that provide additional functionality for other types of thin or no client web applications 100. The application services 1600 stream one or more feeds 1602-1606 to the thin or no client application 100. For example, in various exemplary embodiments, the XML feed 1604 can be implemented as a simple XML protocol. In contrast, the RSS feed 1606 can be implemented as one or more formatted RSS feeds. For example, the GeoRSS feed 1602 can be implemented as one or more RSS namespace extension feeds. It should be appreciated that, in various exemplary embodiments of the server system 1000 according to this invention, the RSS protocol has been extended by providing namespace extensions to the conventional RSS protocol.

As shown in FIG. 2, the server system 1000 can be connected to a variety of different thin or no client applications 3000. These thin or no client applications 3000 can include command and control applications 3100 for the military, the police, search and rescue operations and other organizations. They can also include government applications 3200, which might be used by police, fire, maintenance, emergency and other government organizations. They can also include supply and logistics applications 3300, which may be used by governmental, military, business and other organizations. They can further include GPS and/or RFID tracking applications, which may be used by a wide variety of organizations. It should be appreciated that, depending on the specific needs of the users, any of these thin or no client applications may make use of the tracking server 1610, the collaboration server 1620 or some other server 1630 implemented in the application services 1600 in a particular implementation of the server system 1000.

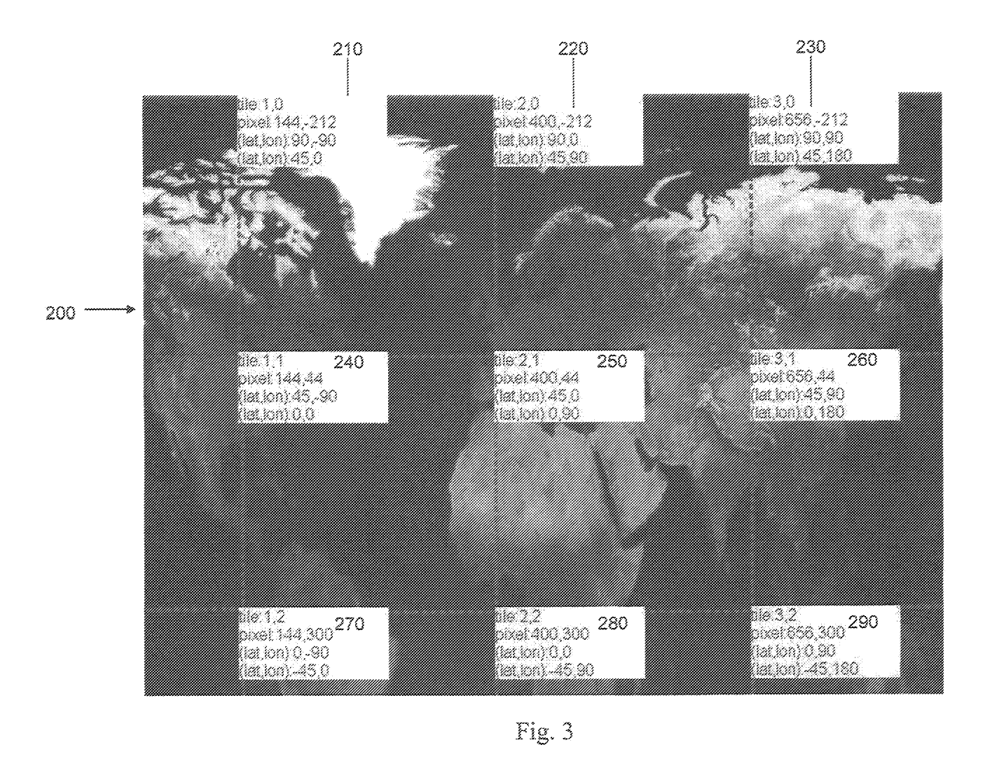

FIG. 3 illustrates image data 200 showing a satellite image of the world that has been ingested and divided by the map service 1200 into a plurality of tiles 210-290. As shown in FIG. 3, each tile 210-290 includes a number of information items, such as a location of that tile in an x,y array. Other information items include the x and y dimensions of the tile, in pixels, and the locations of two opposing corners of the tile within the image data 200. For example, for the satellite image data 200 shown in FIG. 3, the location information is the geospatial, i.e., latitude and longitude, location data of the upper left corner and the lower right corner of each tile. For image data that is not geospatial, such as a CAT scan or an image of a painting, the location information could be the distance of the opposing corners from two perpendicular edges of the image.

The server system 1000 resolves restrictions in various exemplary embodiments of thin or no client applications, such as the thin or no client framework or programming model used to implement the thin or no client application 100 described above and disclosed in the incorporated 700 Provisional Patent Application. As outlined above, in various exemplary embodiments, the code that implements the thin or no client application 100 is written in JavaScript, which is a difficult programming language. The JavaScript code implementing the thin or no client application 100 is restricted and particularly difficult to debug. In particular, JavaScript has no access to databases and cannot persist information from web page to web page as a user navigates through a web site. These operations are enabled using support from various services implemented in the server system 1000 shown in FIG. 2.

It should be appreciated that the JavaScript framework, or programming model, used to implement the thin or client application 100 does make two types of operations easy. First, it is easy for the thin or no client application 100 to issue asynchronous image requests. As the images are retrieved, the browser automatically renders them on the page. Second, it is possible for the thin or no client application 100 to asynchronously request XML files that the JavaScript framework may use to manipulate information displayed using the thin or no client application 100. Because of the difficulty in programming JavaScript, the various services implemented in the server system 1000 do the heavy lifting. It is more efficient to do protocol conversions, calculations and as much computation as possible using the various services implemented in the server system 1000 rather than within the thin or client application 100.

It should be appreciated that, in various exemplary embodiments, the server system 1000 is designed to ingest data by accepting the data to be ingested and processed in as many different formats as possible, with particular focus on open standards. This data to be ingested includes raster image data, feature data, and generic business data.

As mentioned above, the image services 1100, the data services 1500 and the application services 1600 resolve the computational limitations on processing the raw data that are present in the thin or no client application 100. As discussed above, browser-based code written in JavaScript is severely limited. Thus, it is not possible to do many computations that are easily done in fat-client or applet code. The server system 1000 resolves this problem by abstracting the details of programming against the individual browser in which the thin or no client application 100 is running. This allows a web developer, who is creating a particular thin or no client application, to be able to program against a single graphics API.

In various exemplary embodiments, this single graphics API is implemented as a JavaScript library implemented in the image services 1100 of the server system 1000. In various exemplary embodiments, this JavaScript library comprises a number of object classes. When the user accesses a thin or no client application 100 using a particular browser, the image services 1100 of the server system 1000 interrogate that browser's rendering environment at run-time to determine the vector graphics supported by that browser. The image services 1100 of the server system 1000 then conditionally execute the appropriate vector graphics code to create the vector objects.

For example, a user who uses the Firefox browser to browse to a page that had been created with using the JavaScript framework, or programming model, according to this invention would typically see the native SVG that the code on that page generates. However, a user who uses Internet Explorer browser to browse to that same page would typically see SVG in an embed tag, assuming that user has a plug-in that supports SVG. Otherwise, the image services 1100 of the server system 1000 would fall back to generating the native VML that is supported in Internet Explorer. Of course, it should be appreciated that this behavior can be overridden by the developer to force specific rendering engines to be used.

This approach allows a web developer to make simple calls to the single graphics API, such as “DrawRectangle” or “DrawCircle” and not be concerned with the specifics of each browser's rendering capability. The JavaScript library classes implemented in various exemplary embodiments of the image services 1100 of the server system 1000 provide this layer of abstraction and make it much easier for the developer of a thin or no client application to use native vector graphics in that thin or no client application. In addition, this model is flexible and easy to extend, such that, when new browsers are released, the same application code should work without requiring any changes. New classes can be added to the underlying graphics API without changing the existing signature of any of the graphics API calls.

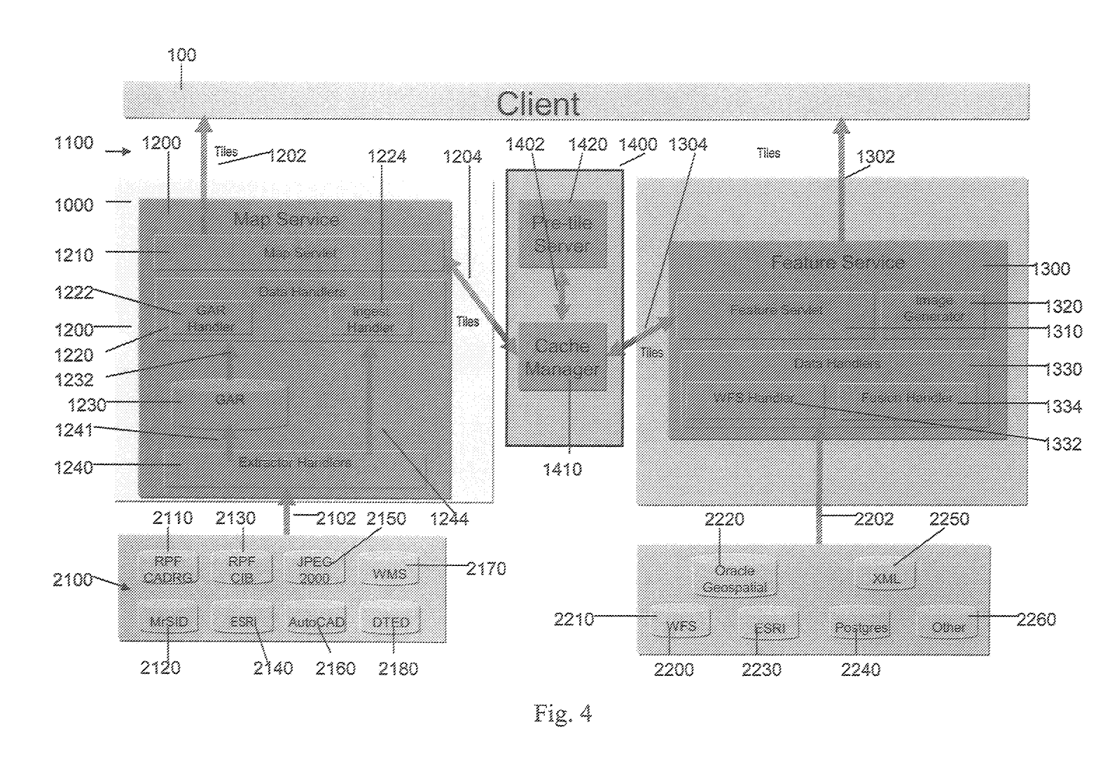

FIG. 4 is a block diagram showing in greater detail one exemplary embodiment of the image services 1100 of the server system 1000 shown in FIG. 2. It should be appreciated that, in various exemplary embodiments, the image services 1100 performs one or more of four broad functions. First, the image services 1100 provides a WMS (web mapping service) compatible interface to a broad set of image formats. In various exemplary embodiments, the thin or no client application 100 is a WMS (web mapping service) compatible client. That is, the image data has a plurality of layers, where each layer represents a different level of zooming or magnification into the image. In such exemplary embodiments, the thin or no client application 100 requests image layers and image tiles using the WMS (web mapping service) specification. In the WMS specification, there are two requests. A “GetCapabilities” request returns the available layers and styles available within each such layer. A “GetMap” request returns the image tiles. The image services 1100 provides a WMS-compatible interface to image repositories that may or may not themselves provide a WMS interface. In various exemplary embodiments, the image services 1100 uses the “GetCapabilities” request. In various other exemplary embodiments, the image services 1100 does not need to use the “GetCapabilities” request, as it may be easier for the thin or no client application 100 to make sense of it without using the “GetCapabilities” request. In various exemplary embodiments, the image services 1100 supports either use.

Second, the image services 1100 renders feature data onto feature image tiles. For example, in a geospatial analysis problem, much of the relevant information, such as roads, cities, bridges, and the like might be stored as feature data in various geospatial databases. In many geospatial applications, feature information is typically rendered on top of the raster image data. In various exemplary embodiments, because of the limited computational and scalability of the thin or no client application 100, this feature data is rendered and streamed to the client as raster image feature tiles by the image services 1100. In various exemplary embodiments, the image services 1100 provide a WMS GetCapabilities-like interface so that the thin or no client application 100 is able to determine what feature data is available.

Third, in various exemplary embodiments, the image services 1100 enables normalization across unique image formats and other data formats. Source images may originate in a variety of different formats. Because the thin or no client application 100 does not have substantial processing power, the image services 1100 formats and modifies the image data so that a consistent user experience with accurate data can be achieved using the thin or no client application 100. In various exemplary embodiments, the image services 1100 reads the original source image data in its native format, and normalizes, re-projects, and co-locates the source image data. The image services 1100 then renders the processed image data to a format that is easily consumable by the thin or no client application 100.

In various exemplary embodiments, to provide additional flexibility, the image conversions can be run in a real-time mode or using an off-line mode. In certain situations, real-time conversion is preferred, so the image services 1100 passes the converted data directly to the thin or no client application 100. If real-time conversion is not possible or desirable, the anticipated image data can be accessed and converted at a time prior to when the image services 1100 will be used. The converted images can then be stored in an efficient off-line format, which can be expressly tuned for fast image retrieval with minimal processing for the thin or no client application 100.

Fourth, in various exemplary embodiments, the image services 1100 provides caching services. It should be appreciated that image processing is computationally expensive. Thus, caching the processed image data reduces redundant image processing operations, preserving server resources of the server system 1000 and enabling the image services 1100 to provide faster support for the thin or no client application 100. In various exemplary embodiments, the image services 1100 includes a tile cache 1400 that is organized into fixed zoom levels and layers within each level.

In various exemplary embodiments, the thin or no client application 100 requests image tiles within the image displayed in the image view 160 at fixed locations and at fixed zoom levels corresponding to fixed resolutions. Caching these image tiles greatly improves system performance. In various exemplary embodiments, the tile cache 1400 services implemented in the image services 1100 also includes pre-tiling support, where image tiles for specified regions and zoom levels within the displayed image are placed into the tile cache 1400 through batch requests in advance of their use by the thin or no client application 100, rather waiting to dynamically place such image tiles into the tile cache 1400 as those image tiles are processed by the image services 1100 in response to requests by the thin or no client application 100.

The exemplary embodiment of the image services 1100 shown in FIG. 4 includes the map service 1200, the feature service 1300 and the tile cache 1400. The map service 1200 can include some or all of a map servlet 1210, a plurality of data handlers 1220, including a preprocessed image archive handler 1222 and an ingest handler 1224, a preprocessed image archive 1230 and a plurality of extractor handlers 1240. The feature service 1300 includes a feature servlet 1310, an image generator 1320, and a plurality of data handlers 1330, including one or more of a WFS (web feature service) handler 1332 and a fusion handler 1334. The tile cache 1400 includes a cache manager 1410 and a pre-tile server 1420.

The pre-tile server 1420 enables an administrator to pre-populate the tile cache 1400 with image tiles from the map service 1200 and the feature service 1300 that the administrator anticipates will be used. Pre-populating the tile cache 1400 improves performance and reduces latency because the necessary image tiles are already cached locally and the underlying image data does not need to be retrieved from one of the image or feature data sources 2100 or 2200.

The tile cache 1400 comprises the cache manager 1410 and a cache class that is usable to store image and feature tiles. The cache manager 1410 decides where to store and retrieve the image and feature tiles, making sure the necessary directories exist, and creating the cache objects for use programmatically. The cache class is responsible for knowing how to determine whether a particular image exists, storing images in the proper place, and retrieving images. If there is an error in retrieving an image, the cache object will return a default error tile. The map servlet 1210 or the feature servlet 1310, when it needs to interact with the tile cache 1400, can request a cache object from the cache manager 14110 and use that cache object to store and retrieve image or feature tiles.

FIG. 4 also shows exemplary embodiments of a set of image repositories or data sources 2100 and a set of feature data repositories or data sources 2200. As shown in FIG. 4, in this exemplary embodiment, the set of image data sources 2100 includes one or more of an RPF CADRG data source 2110, a MrSID data source 2120, an RPF CIB data source 2130, an ESRI image data source 2140, a JPEG 2000 data source 2150, an AutoCAD data source 2160, a WMS (web mapping service) data source 2170 and/or a DTED data source 2180, and can include other known or later-developed image data sources. The set of feature data sources 2200 includes one or more of an WFS (web feature service) data source 2210, an Oracle Geospatial data source 2220, an ESRI feature data source 2230, a Postgres data source 2240, an XML data source 2250 and/or one or more other known or later-developed image data sources 2260.

As shown in FIG. 4, the extractor handlers 1240 input or pull requested image data from various ones of the image data sources 2100. The requested image data is defined in an asynchronous image data request received from the thin or no client application 100. In various exemplary embodiments, the map servlet 1210 receives the image data request from the thin or no client application 100 and queries the cache manager 1410 over a bi-directional data path 1204 to determine if image tiles corresponding to the requested image data are already present in the tile cache 1400. If so, the cache manager 1410 returns the previously-stored tiles corresponding to the requested image data from the file cache 1400 to the map servlet 1210 over the bi-directional data path 1204. The map servlet 1210 then asynchronously streams those image tiles to the thin or no client application 100 as the image tiles 1202.

If image tiles corresponding to the requested image data have not already been stored in the tile cache 1400, the image data request from the thin or no client application 100 is forwarded from the map servlet 1210 to the extractor handlers 1240. The extractor handlers 1240 locate the requested image data in one of the plurality of image data sources 2100. The extractor handlers 1240 input the image data from the particular image data source 2100 in the native format of that image data source 2100 and convert the image data into a defined format. The reformatted image data is then either provided to the preprocessed image archive 1230 over a first data path 1241 or to the ingest handler 1224 over a second data path 1244. The preprocessed image archive 1230 stores the reformatted image data until some item of image data stored in the preprocessed image archive 1230 is requested. At that time, the preprocessed image archive 1230 provides the requested image data over a third data path 1232 to the preprocessed image archive handler 1222.

The extractor handlers 1240 enable the map service 1200 to connect to different data sources. It would normally be expected that the map service 1200 would need one specifically-designed extractor handler 1240 for each different data source that the map service 1200 ingests data from. However, because an extractor handler 1240 for a new data according to this invention source can be readily added to the map service 1200, the map service 1200 is readily extensible, and does not require wholescale rewriting to allow such new data sources to be incorporated into the server system 1000.

In effect, with respect to the map service 1200, the extractor handlers 1240 are “plug and play”. That is, the interface of each extractor handler 1240 is metaphorically “cut in the exact same shape”. When the map service 1200 needs to ingest data that is in a new format, it becomes simple to add, in place of or in addition to, the current extractor handlers 1240, a new extractor handler 1240, since the new extractor handler 1240 “is cut the same way”, so the new extractor handler 1240 is guaranteed to integrate into the map service 1200. In effect, while there are multiple extractor handlers 1240, each extractor handler 1240 looks the same to the map service 1200, as their interfaces are indistinguishable. This allows the map service 1200 to add any necessary or desirable extractor handler 1240 and know that it will behave in the same way as any other extractor handlers 1240.

The preprocessed image archive and ingest handlers 1222 and 1224 convert the provided image data into a plurality of tiles, which are provided to the map servlet 1210. The map servlet 1210 outputs the tiles as an asynchronous data stream 1202 to the thin or no client application 100. At the same time, the map servlet 1210 provides those image tiles over the bi-directional data path 1204 to the cache manager 1410 of the tile cache 1400. The cache manager 1410 stores the received tiles in the tile cache 1400, which stores the received tiles in case a subsequent request should again request that image data.

Similarly, requested feature data is defined in an asynchronous feature data request received from the thin or no client application 100. In various exemplary embodiments, the feature data request is received from the thin or no client application 100 by the feature servlet 1310 of the feature service 1300. It should be appreciated that the feature service 1310 can stream the requested feature data as vector feature data, such as, for example, SVG objects, or as raster data tiles, or “feature tiles”, that are generated by the feature services 1300. In various exemplary embodiments, the feature services 1300 returns feature tiles when the thin or no client application does not have sufficient processing power to render the vector feature data or is too thin. This can occur, for example, with mobile devices.

When the feature services 1300 will return vector feature data, the feature data request from the thin or no client application 100 is forwarded from the feature servlet 1310 to the data handlers 1330. The data handlers 1330 locate the requested vector feature data in one or more of the plurality of feature data sources 2200. The data handlers 1330 input the vector feature data from the particular feature data source 2200 in the native format of that feature data source 2200 and convert the vector feature data into a defined vector format. The reformatted feature data is then provided to the feature servlet 1310. The feature servlet 1310 streams the vector feature data as an asynchronous data stream 1302 to the thin or no client web application 100.

The data handlers 1330 enable the feature services 1300 to connect to different data sources. It would normally be expected that the feature services 1300 would need one specifically-designed data handler 1330 for each different data source that the feature services 1300 ingests data from. However, because a data handler 1330 for a new data according to this invention source can be readily added to the feature services 1300, the feature services 1300 is readily extensible, and does not require wholescale rewriting to allow such new data sources to be incorporated into the server system 1000.

In effect, with respect to the feature services 1300, the data handlers 1330 are “plug and play”. That is, the interface of each data handler 1330 is metaphorically “cut in the exact same shape”. When the feature services 1300 needs to ingest data that is in a new format, it becomes simple to add, in place of or in addition to, the current data handlers 1330, a new data handler 1330, since the new data handler 1330 “is cut the same way”, so the new data handler 1330 is guaranteed to integrate into the feature services 1300. In effect, while there are multiple data handlers 1330, each data handler 1330 looks the same to the feature services 1300, as their interfaces are indistinguishable. This allows the feature services 1300 to add any necessary or desirable data handler 1330 and know that it will behave in the same way as any other data handlers 1330.

When the feature services 1300 will return feature tiles to the thin or no client web application 100, the feature servlet 1310 queries the cache manager 1410 over a bi-directional data path 1304 to determine if one or more feature tiles corresponding to the requested feature data are already present in the tile cache 1400. If so, the cache manager 1410 returns the previously-stored tiles corresponding to the requested feature data from the tile cache 1400 to the feature servlet 1310 over the bi-directional data path 1304. The feature servlet 1310 then asynchronously streams those image tiles to the thin or no client application 100 as the feature tiles 1302.

If feature tiles corresponding to the requested feature data have not already been stored in the tile cache 1400, the feature data request from the thin or no client application 100 is forwarded from the feature servlet 1310 to the data handlers 1330. The data handlers 1330 locate the requested feature data in one or more of the plurality of feature data sources 2200. The data handlers 1330 input the feature data from the particular feature data source 2200 in the native format of that feature data source 2200 and convert the feature data into a defined format. The reformatted feature data is then provided to the image generator 1320. The image generator 1320 converts the feature data into one or more feature tiles, i.e., raster image data tiles, and outputs the feature tiles as an asynchronous data stream 1302 to the thin or no client web application 100. At the same time, the feature servlet 1310 provides those feature tiles over the bi-directional data path 1304 to the cache manager 1410 of the tile cache 1400. The cache manager 1410 stores the received tiles in the tile cache 1400, which stores the received feature tiles in case a subsequent request should again request that feature data.

That is, the image services 1100 are responsible for ingesting image data and feature data. It should be appreciated that, in various exemplary embodiments, the image data is any type of raster or bytemap data. Such image data includes, for example, satellite photographs, image data from a scanner or the like, digital photographs and any other known or later-developed types of image data. In contrast, it should be appreciated that, in various exemplary embodiments, the feature data is data defined as objects, such as, for example, locations of roads, buildings, etc. that represents items within the image data. In various exemplary embodiments, whether image data or feature data, the image services 1100 renders that information into constant pixel-width and constant pixel-height raster-data tiles and streams the resulting tiles asynchronously to the thin or no client application 100.

As outlined above, it is generally not possible to do anything but the simplest image processing operations within the thin or no client application 100. Operations such as image re-projecting, warping, rendering of feature data, and combining image and feature data should be done within the server system 1000 and the results streamed to the thin or no client application 100 as the image tiles 1202 and/or the feature tiles 1302. Ready access to such pre-processed image data is needed for the thin or no client application 100 to provide smooth panning and zooming within the image view 160.

It should be appreciated that, for example, geospatial data can be broken into two broad camps. Map image data, which is typically in raster or bytemap format, is the “pixels” of the terrain and area. Feature, item or object data, which is often in vector format, is a data structure that represents the map data as geometric objects, e.g. polygons, curves, and lines. In various exemplary embodiments, the image services 1100, via the map services 1200 and the feature services 1300, addresses both types of data. Raster format data passes through the extractor handlers 1240, which convert the raster format image data from the source format into a format that is consumable by the map services 1200. Once converted, the image data is either cached into the preprocessed image archive 1230 or is passed to the thin or no client application 100 to be displayed to the user or both.

Whether the image is stored in the preprocessed image archive 1230 depends on deployment constraints. It should be appreciated that the preprocessed image archive 1230 enables a trade off between the processing power needed to convert the image data into the image tiles versus the storage space needed to store the cached image data, as the preprocessed image archive format is optimized for streaming delivery to the thin or no client application 100. Therefore, substantial storage space is needed. The architecture of the map services 1200 and the tile cache 1400 allows both image conversion strategies to be used. The pre-tile server 1420 allows for an off-line process to initiate the processing and consumption of images from a remote server into the cache manager 1410 so that the image tiles are stored locally, optimizing the end-user experience.

As outlined above, feature (or vector format) data is handled in a slightly different way than the image data. The feature data can be delivered to the thin or no client application 100 using either of two formats. In various exemplary embodiments, the feature data is provided by the feature services 1300 to the thin or no client application 100 as vector data. In such exemplary embodiments, the thin or no client application 100 renders the vector data using, for example, SVG or XAML. In various other exemplary embodiments, such as, for example, when the thin or no client application 100 has less processing power, the feature data is converted by the feature services 1300 into the feature tiles. As outlined above, the feature tiles are delivered to the thin or no client application 100 as raster image data that is overlaid on the image tiles. The feature services 1300 processes the feature data by normalizing the feature data so that the feature data, whether formatted as vector data or as features tiles, is at the same pixel size and projection as the image tiles. This allows the thin or no client application 100 to be able to simply and seamlessly overlay the feature data onto the image tiles. The feature data is processed by the data handlers 1330, and is optionally stored in the tile cache 1400, depending on the particular deployment constraints for the associated thin or no client application 100.

As discussed above, the map service 1200 ingests image data from common image format sources, including OGC WMS (web mapping service) compliant servers 2170, NGA RPF CADRG and CE3 sources 2110 and/or 2130, MrSID sources 2120, JPG 2000 sources 2150, AutoCAD and other AutoDesk sources 2160, and other sources that provide image data in a particular image format. It should be appreciated that the architecture of the extractor handlers 1240 is extensible and that it is generally easy to extend the extractor handlers 1240 to handle additional image data formats.

As discussed above, requests to the map service 1200 are received by the map servlet 1210. In various exemplary embodiments, the map servlet 1210 parses the incoming request and stores the parameters in a request object for future use. The map servlet 1210 handles GetCapabilities requests by directly retrieving the “Capabilities” document from the remote WMS (web mapping service) source 2170 into a local XML document. The map servlet 1210 then returning the local XML document to the requesting thin or no client application 100. The map servlet 1210 handles GetMap requests (i.e., requests for image data) by passing the GetMap request along to the ingest handler 1224 or the preprocessed image archive handler 1222.

The map servlet 1210 passes the image request to the ingest handler 1224. As outlined above, the WMS (web mapping service) format organizes the image data into magnification or zoom levels and, within each level, divides the image data into raster or bytemap image tiles. In response to that GetMap request, the ingest handler 1224 first checks, using the data path 1204, the tile cache 1400 for tiles corresponding to the requested image data. If such image tiles exists in the tile cache 1400, those image tiles are retrieved from the tile cache 1400 to the map servlet 1210 over the data path 1204. The map servlet 1210 then returns those image tiles 1202 to the thin or no client application 100.

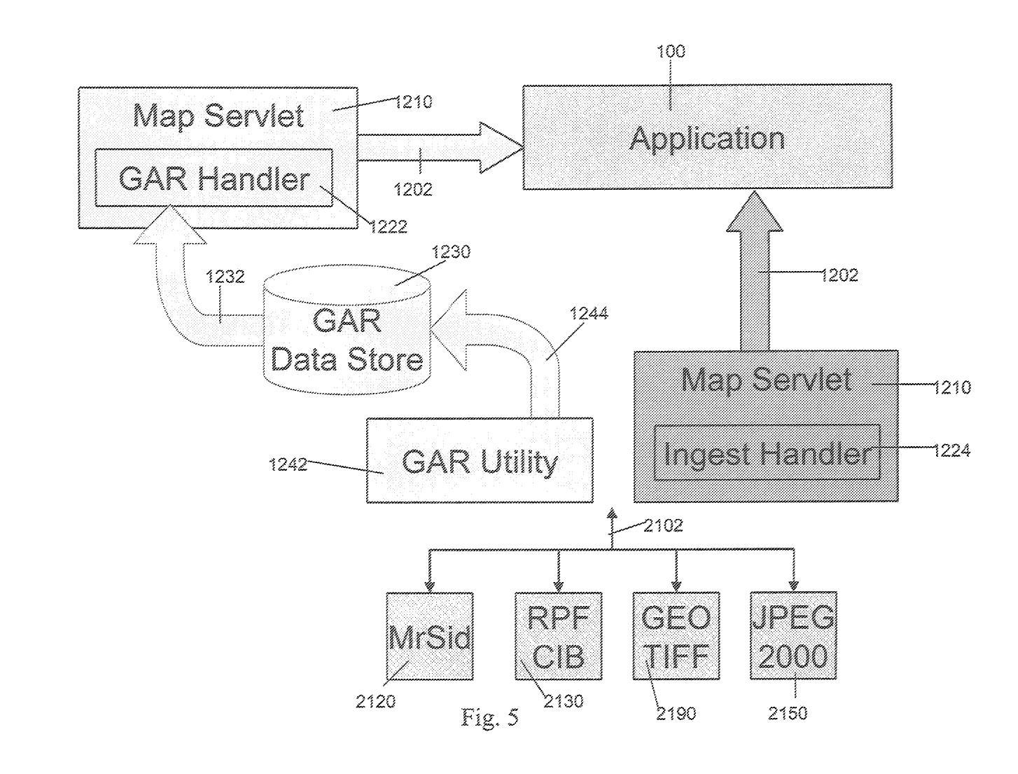

FIG. 5 illustrates the operation of the ingest handler 1224 and the preprocessed image archive handler 1222. The ingest handler 1224 or the preprocessed image archive handler 1222 are used when the requested image data is not already stored in the tile cache 1400. In this situation, the ingest handler 1224 analyzes the GetMap request received from the thin or no client application 100. Based on that analysis, the ingest handler 1224 assembles an appropriate HTTP GET query string to connect to the remote WMS source 2170. That query is sent out by the ingest handler 1224 to the WMS source 2170. In response, the WMS source 2170 returns the requested image data tiles directly to the ingest handler 1224, as no extraction processing by the extractor handlers 1240 is necessary. The image tiles are then returned by the map servlet 1210 to the thin or no client application 100. Those image tiles are also provided by the ingest handler 1224 to the tile cache 1400, which stores those image tiles future use.

It should be appreciated that image requests other than GetMap requests can be received by the map servlet 1210 from the thin or no client application 100. In various exemplary embodiments, the map servlet 1210 passes the image request to the ingest handler 1224. The ingest handler 1224, using the data path 1204, again first checks the tile cache 1400 for image tiles corresponding to the requested image data. If such image tiles are present in the tile cache 1400, those image tiles are retrieved from the tile cache 1400 and returned to the ingest handler 1224 over the data path 1204. The returned image tiles are then passed by the ingest handler 1224 to the map servlet 1210, which returns the image tiles 1202 corresponding to the requested image data to the thin or no client application 100.

Otherwise, the ingest handler 1224 retrieves the requested image data from the desired image data source 2100 via an appropriate one of the extractor handlers 1240. After that extractor handler 1240 inputs and processes the requested image data into image tiles, the image tiles are returned by that extractor handler 1240 to the ingest handler 1224. Again, the returned image tiles are then passed by the ingest handler 1224 to the map servlet 1210, which returns the image tiles 1202 corresponding to the requested image data to the thin or no client application 100. Those image tiles are also provided by the ingest handler 1224 to the tile cache 1400, which again stores those image tiles future use.

It should be appreciated that, in general, one extractor handler 1240 is necessary for each different native image format that will be used by the thin or no client application 100. Typically, each native image format present in the image data sources 2100 is handled by a different one of the extractor handlers 1240. Each extractor handler 1240 contains at least sufficient knowledge about a particular image format to allow that extractor handler 1240 to extract the image data from that image data source 2100 and reformat it for the map services 1200. It should be appreciated that, for a given image format, a single one of the extractor handlers 1240 can be used both in a pre-process extraction mode to supply the image data to the preprocessed image archive 1230 and in a dynamic extraction mode to supply the image data.

It should be appreciated that the image data request received from the thin or no client application 100 typically specifies the location of the requested image data on one of the image data sources 2100. This is typically done by either specifying a full path in the image data request or by specifying a name in the image data request that is resolved on a server for the image data source 2100. For a given image format, the extractor handler 1240 for that given image format extracts the requested image data, as well as metadata about the extracted image data, from the raw image data on the specified image data source 2100. That extractor handler 1240 then reformats the extracted image data into raster form, i.e., into image tiles.

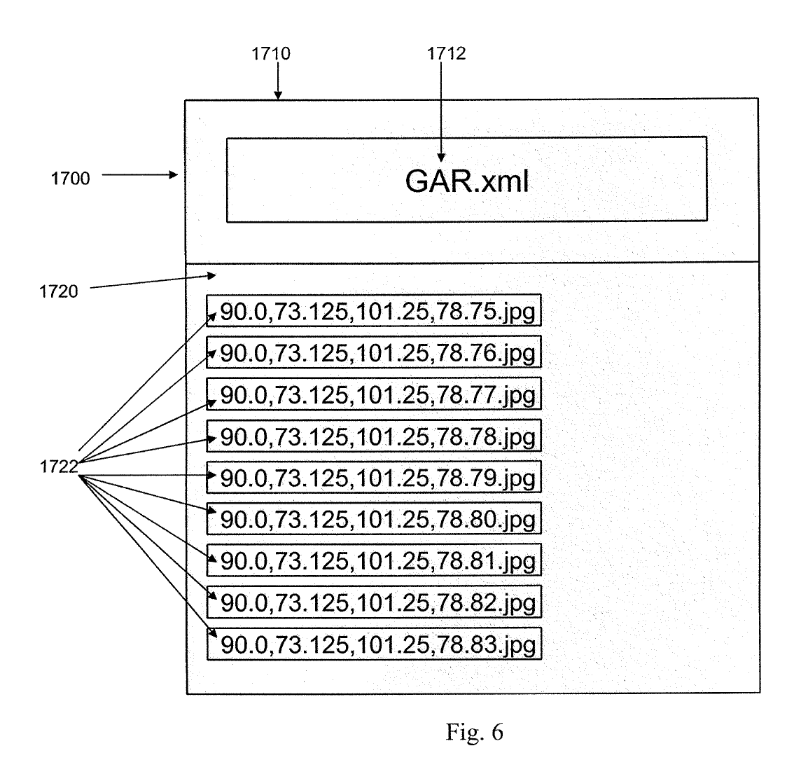

In contrast to using the ingest handler 1224 to access data from one of the data sources 2100, an archive of anticipated data, the preprocessed image archive 1230 can be used to locally store that data. FIG. 6 illustrates one exemplary embodiment of a preprocessed image archive-format image archive file 1700. Native image data formats can be inefficient to process on the fly one tile at a time. Accordingly, it is often more efficient to pre-convert the native format image data files into tiles in batches instead of one tile at a time. The preprocessed image archive utility 1242 shown in FIG. 5 can be used to convert native format image data files into preprocessed image archive-format image archive in an efficient manner. A preprocessed image archive format provides an efficient way for the preprocessed image archive handler 1222 to then ingest the requested image tiles, one at a time, and return the requested image tiles to the requesting thin or no client application 100.

The image data in a preprocessed image archive-format image archive file is stored as fixed width pixel image tiles in the preprocessed image archive format. FIG. 6 shows one exemplary embodiment of a preprocessed image archive-format image archive file 1700. The preprocessed image archive format allows any image format to be pre-processed into a group of image tiles that the requesting thin or no client application 100 can use. In various exemplary embodiments, the preprocessed image archive format is built upon the industry standard Zip format, where images are stored together in a single archive file.

The preprocessed image archive format extends the basic Zip format by including metadata about the extracted images. This metadata is stored in the GAR.xml file 1712 that is located in a header 1710 provided inside the preprocessed image archive-format image archive file 1700. The GAR.xml file 1712 includes information such as the name of the file from which the images were extracted, the date and method for capturing the images, and information about the process for extracting the images into the archive. The images portion 1720 of the preprocessed image archive-format image archive file 1700 includes a plurality of image tile files 1722. The file name for each image tile file 1722 denotes the lower left and the upper right bounding box coordinates. From these lower left and the upper right bounding box coordinates, the preprocessed image archive handler 1222 is able to infer information about the image tiles in a particular image tile file 1722, such as, for example, meters per pixel and zoom level.

The preprocessed image archive handler 1222 retrieves the image tiles from the preprocessed image archive 1230. The map servlet 1210 passes the received image request to the preprocessed image archive handler 1222. Like the ingest handler 1224, the preprocessed image archive handler 1222 checks the tile cache 1400 for the requested image tiles. If the requested image tiles exist in the tile cache 1400, those image tiles are returned by the cache manager 1410 to the preprocessed image archive handler 1222. The preprocessed image archive handler 1222 returns those image tiles to the map servlet, which returns them to the requesting thin or no client application 100. Otherwise, the preprocessed image archive handler 1222 accesses the appropriate preprocessed image archive-format image archive file 1700 stored in the preprocessed image archive 1230, based on the path (which can be either a fall path name or a name resolved on the server) that is specified in the received request, and reads the requested image tiles from that preprocessed image archive-format image archive file 1700. The preprocessed image archive handler 1222 again returns the retrieved image tiles to the map servlet 1210. The map servlet 1210 then returns the image tiles 1202 to the requesting thin or no client application 100. The map servlet 1210 also provides those image tiles 1202 over the data path 1204 to the tile cache 1400 for future use.

The preprocessed image archive utility 1242 shown in FIG. 5 interfaces with an extractor handler 1240 to save image data into a preprocessed image archive-format image archive file 1700. The image data is later provided to the thin or no client application 100 using the preprocessed image archive handler 1222. In various exemplary embodiments, the preprocessed image archive utility 1242 takes advantage of the extractor factory to determine which extractor handler 1240 to use with the source image data. This allows newly written extractor handlers 1240 to extend the preprocessed image archive utility 1242. In such exemplary embodiments, each extractor handler 1240, via the extractor interface, should be able to return a list of meta-data about the source image in the form of a properties list.

A source image format may contain many different types of geo-spatial and other appropriate image data that may have various properties. The properties that are available to the map services 1200 for a specific image format is determined solely by the extractor handler 1240 for that image format. This meta-data property list can be retrieved from an extractor handler 1240 using a “getMetadata” method. Each property in the property list contains a list of possible values for that property and reflects the actual available image data that that extractor handler 1240 is capable of extracting. The preprocessed image archive utility 1242 uses this property list to give the user control of what to include in a preprocessed image archive-format image archive file 1700. In various exemplary embodiments, by knowing which properties and which values are available, the user is able to specify a filter that the preprocessed image archive utility 1242 passes to a “getTile” method in the appropriate extractor handler 1240 to create the desired preprocessed image archive-format image archive file 1700. This filter is a subset of the property list returned by the “getMetadata” method. By specifying a subset of properties and values, the user can create a preprocessed image archive-format image archive file 1700 from a subset of the source image data using the preprocessed image archive utility 1242.

The extractor handlers 1240 provide an extensibility framework for the map services 1200. As a new image format arises, a new extractor handler instance 1240 can be constructed to input image data into the map services 1200 without needing to modify other areas of the map services 1200, the image services 1100 or the server system 1000. In this way new image formats can be plugged into the existing server system 1000. This extensibility framework works by providing two components: an extractor factory and an extractor interface. All of the extractor handlers 1240 adhere to the extractor interface, which provides a common ground and requirements that all extractor handlers 1240 must satisfy. One such requirement is that each extractor handler 1240 must be able to determine if that extractor handler 1240 can extract a specified file or directory through a “canIngest” method. The extractor factory is a component of the extractor handlers 1240 that chooses the best extractor handler 1240 for a specific file or directory. The extractor factory uses the “canIngest” method to determine which extractor handler 1240 is the most appropriate for a specified image data source 2100.

The Open Geospatial Consortium (OGC) has defined a Web Feature Service (WFS) Implementation Specification. WFS allows a client to retrieve and update geospatial data encoded in Geography Markup Language (GML) from multiple Web Feature Services. As outlined above, the feature service 1300 is designed to retrieve WFS data, convert the retrieved WFS data into fixed-width feature tiles that have a transparent background, and deliver them to the thin or no client application 100. It should be appreciated that the feature service 1300 can also deliver the retrieved WFS data to the thin or no client application 100 in a GeoRSS web feed.

When a request for feature data is received from the thin or no client application 100 by the feature servlet 1310, similarly to the map servlet 1210, the feature servlet 1310, via the data path 1304, first looks into the tile cache 1400 to see if a feature tile corresponding to the requested feature data is present in the tile cache 1400. If such a feature tile does, that cached feature tile is provided by the tile cache manager 1410 from the cache 1400 to the feature servlet 1310 over the data path 1304. The feature servlet 1310 then immediately returns that retrieved feature tile to the requesting thin or no client application 100.

If a feature tile corresponding to the requested feature data is not available in the tile cache 1400, the requested WFS feature data is retrieved by the WFS handler 1332 from the WFS data source 2210. The retrieved WFS feature data is processed, and plotted as one or more raster or bytemap feature tiles by the WFS handler 1332, which returns the one or more feature tiles to the feature servlet 1310. The feature servlet 1310 then streams the one or more feature tiles 1302 to the client and saves the one or more feature tiles as PNG images into the tile cache 1400.

The WFS data source 2210 handles three specific requests. In response to a “GetCapabilities” request, the WFS data source 2210 returns a service metadata XML document that describes its capabilities. In response to a “DescribeFeatureType” request, the WFS data source 2210 generates an XML schema description of feature types serviced by that WFS data source 2210. In response to a “GetFeature” request, the WFS data source 2210 returns a result set that is modeled after the Features GML representation.

All three requests are handled by the feature service 1300. For both GetCapabilities and DescribeFeatureType requests, the generated response that is returned from the WFS data source 2210 is loaded into an XML document by the feature service 1300 to validate proper XML structure. This document is then returned to the requesting thin or no client application 100. The GetFeature request returns GML-encoded geospatial data that describes the requested features.

Requests to the feature service 1300 are received by the feature servlet 1310. The feature servlet 1310 parses the incoming request and stores the parameters for future use. These values are accessible through appropriate “getters” for the parameters. The feature servlet 1310 also directs the different WFS operations in the appropriate way. In response to GetCapabilities or DescribeFeatureType requests, the feature servlet 1310 retrieves the appropriate document from the WFS data source 2210 and loads the retrieved document into a local XML document. The feature servlet 1310 then returns this XML document to the requesting thin or no client application 100. The feature servlet 1310 passes a GetFeature request to the WFS handler 1332.

The WFS handler 1332 uses an HTTP GET request to retrieve feature data from a WFS data source 2210. The WFS handler 1332 specifies in the query string of the HTTP GET request both “typename” and “bbox” parameters. The value for the “typename” parameter is one entry of a list of available types listed in the GetCapabilities document. The “bbox” parameter specifies the coordinates of a box within which the interesting features lie. The returned GML-encoded feature data contains location data within the “world” of the image for each feature within the specified bounding box (bbox) for the specified typename(s). For geospatial images, this location data is latitude and longitude coordinates. For other “worlds”, such as, for example, medical images or images of a painting, this location data is distance from a specified point in the image.

It should be appreciated that, at the present time, GML (geospatial markup language) supports 3 shapes, points, lines and polygons. The WFS handler 1332 handles all three shapes. Once the GML-encoded feature data is retrieved from the WFS data source 2210, the WFS handler 1332 loads the retrieved GML-encoded feature data into an XML document. The requesting thin or no client application 100 can request that the feature service 1300 return the requested feature data as a GeoRSS web feed. In this situation, the feature servlet 1310 retrieves the XML document from the WFS handler 1332 and converts the GML-encoded feature data in the XML document into a GeoRSS web feed and returns the GeoRSS web feed to the requesting thin or no client application 100. It should be appreciated that the feature service 1300 also supports a custom GeoRSS extension that allows additional information to be included in the GeoRSS web feed and displayed on the requesting thin or no client application 100.

The image generator 1320 creates feature tiles, i.e., raster or bytemap image tiles of the feature data, from the WFS data. It should be appreciated that, in general, features are typically displayed on top of image tiles. Consequently, feature tiles should be transparent, so that the underlying image tiles remain visible under the features included in the feature tiles. The image generator 1320 starts by initializing a blank, transparent feature tile upon which the features are plotted. The image generator 1320 parses the GML-encoded feature data to find the type and location of each feature. The image generator 1320 converts the location data of the feature, such as its latitude and longitude for geospatial features, into an image location (x-pixels, y-pixels) usable to plot that feature onto the raster feature tile. It necessary, the image generator 1320 looks up the feature type up in a configuration file to determine the default color, thickness, or other visual attributes needed to display that feature, as these attributes may not be specified in the GML-encoded feature data.

Once the entire document is processed, the completed raster is saved as a PNG (portable network graphics)-encoded image to preserve transparency and returned by the image generator 1320 to the feature servlet 1310. The feature servlet 1310 then streams the generated feature tiles to the thin or no client application 100. The feature servlet 1310 also provides the generated feature tiles to the tile cache 1400, as described above. One request corresponds to one bounding box, and therefore corresponds to one image.

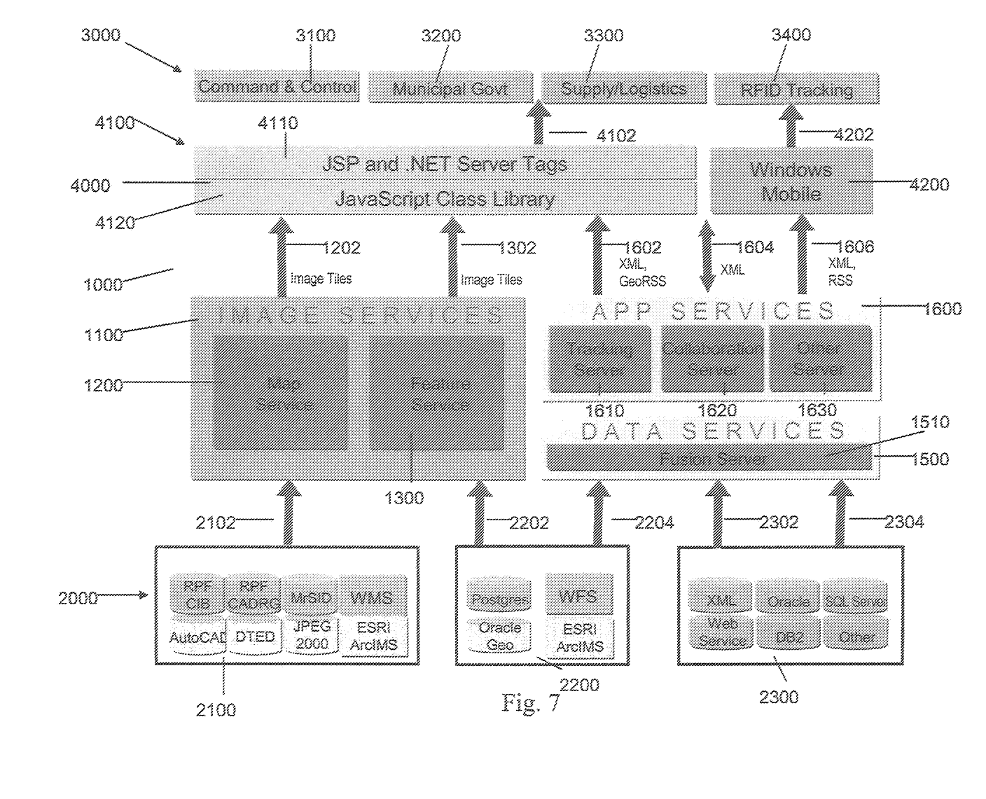

FIG. 7 is a block diagram outlining a second exemplary embodiment of the server system 1000 that supplies one or more asynchronously accessible data streams to the thin or no client application 100 shown in FIG. 1. In this second exemplary embodiment of the server system 1000 shown in FIG. 7, the server system 1000 is generally similar to the first exemplary embodiment of the server system 1000 shown in FIG. 2. However, in this second exemplary embodiment of the server system 1000 shown in FIG. 7, one or more conversion services 4000 are provided between the image services 1100 and the application services 1600 on an upstream side and the thin or no client application 100 on a downstream side. In various exemplary embodiments, the conversion services 4000 comprise one or more of a thin client interface 4100 and a mobile device interface 4200.

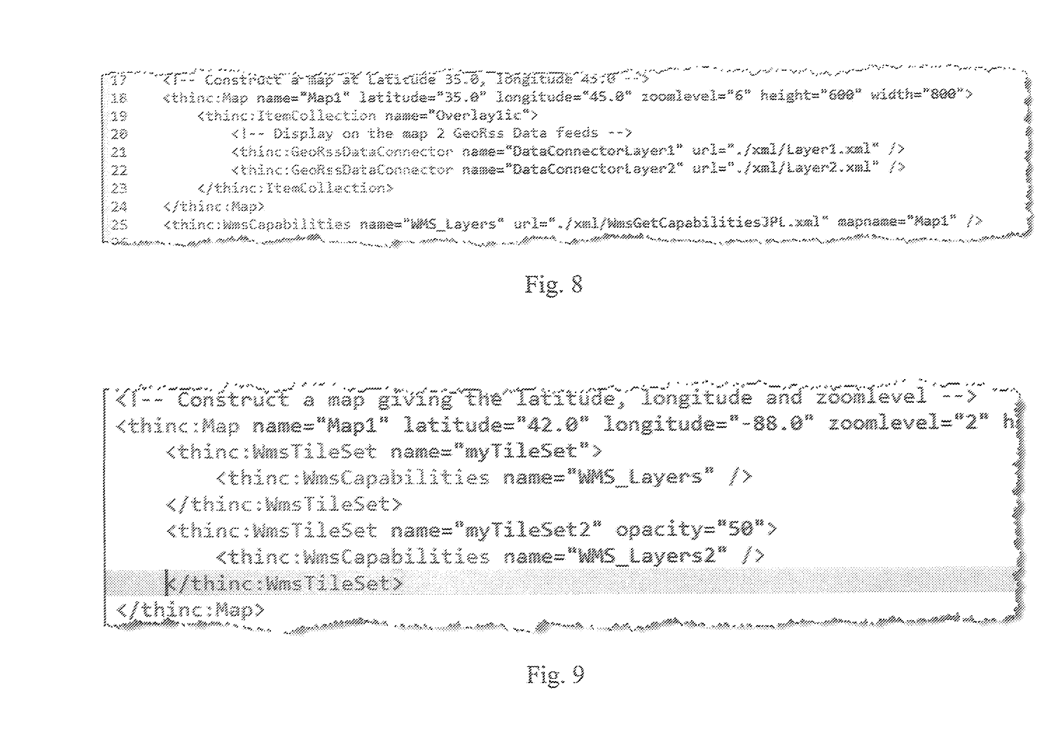

In this second exemplary embodiment, the thin client interface 4100 exposes functionality to the integration developer through HTML server tags implemented in a server tag library 4110. Server tags allow the developer to define the various views 110, 120, 130 and/or 160 and other graphical interface widgets within the thin or no client application 100 inline using an HTML syntax rather than having to use pure JavaScript code. As shown in FIG. 8, JSP and ASPX tags implemented in the server tag library 4110 of the thin client interface 4100 enable web application developers to use the various sophisticated interface visual components disclosed herein by simply including them in the HTML code on the web page that implements the thin or no client application 100.

It should be appreciated that HTML syntax is more readable and therefore more maintainable for a web application developer. Server tags also allow intellisense and syntax checking when used in standard programming environments, such as Eclipse and Microsoft's VisualStudio. By integrating with the popular IDE's (integrated development environments), “drag and drop” support is enabled. This in turn allows the web application developer to design and code the thin or no client application 100 using typical rapid application development (RAD) techniques. This allows syntax errors to be caught at integration time rather than during run time. The server tags implemented in the thin client interface 4100 provide meaningful error messages for the integration developer. Regular HTML error messages provide only generic error messages and codes, such as, for example, “Error 500, “Server Error” and the like. In contrast, the server tags implemented in the thin client interface 4100 provide detailed error messages.

Many of the various views 110, 120, 130 and/or 160 and other graphical interface widgets within the thin or no client application 100 express a hierarchal relationship. For example, the image view 160 might contain 3 overlay regions which to display. Likewise, the bar chart view 110 might contain 3 data sets to plot. The extended server tag library 4110 of the thin client interface 4100 expresses these relationships using XML's natural syntax, which should be familiar to an experienced developer. The standard way to express the relationship is by embedding ID's and using lookup indirection to deduce hierarchy.

It should be appreciated that XHTML is inherently hierarchal, defining many “parent-child” relationships among the XHTML tags. Similarly, many types of location or spatial data, such as, for example, geospatial data, is also inherently hierarchical, with a “parent map” rendering “child data feeds.” In various exemplary embodiments, the extended server tag library 4110 exploits this relationship by exposing an object model as a relationship of nested tags. The server tags implemented in the extended server tag library 4110 express this naturally, as in the following example. In this example, the server tags implemented in the extended server tag library 4110 use the prefix “thinc:”. The following sample code draws a map that is centered at latitude 35 and longitude 45. Feature data is obtained from the “source1” and “source2” URLs and is drawn in the generated map. This hierarchal relationship is clear from the code.

```
<thinc:map latitude=”35.0” longitude=”45.0”>
    <thinc:ItemCollection>
        <thinc:GeoRssDataConnector url=”source1” />
        <thinc:GeoRssDataConnector url=”source2” />
    </thinc:ItemCollection>
</thinc:map>
```

Using hierarchical containment, it is possible to include several different image and datasets into a particular one of the various views 110, 120, 130 and/or 160 and other graphical interface widgets within the thin or no client application 100. As shown in FIG. 8, tags that are contained within other tags feed automatically into the “parent” tag. This allows a natural syntax, and obviates the need to ‘hardcode’ the name in the data tag.

FIG. 9 shows an example of HTML code that includes various ones of the extended server tags implemented in the extended server tag library 4110. This sample code defines an image view 160 that is attached to two different WMS image servers. When this sample code is executed in a thin or no client application 100, both sets of image data are returned to the thin or no client application 100 by the server system 1000 in response to requests received from the thin or no client application 100. The thin or no client application 100 combines the image data and displays the combined image data within the displayed image view 160.

It should be appreciated that, in various exemplary embodiments, the client is able to display a variety of visual components. Each visual component, such as, for example, a bar chart, a pie chart, a geospatial view and the like, receives data from another source and organizes that data into a particular representation of that data. In various exemplary embodiments, client feeds the received data is into the visual components. In various exemplary embodiments, this is done by subsidiary tags that are hierarchically organized inside of main tags. These tags are not based on name value attributes or ids and allow the programmer or user to specify an unlimited number of data sources. In contrast, conventional tags define a one-to-one mapping between a tag and a data source.

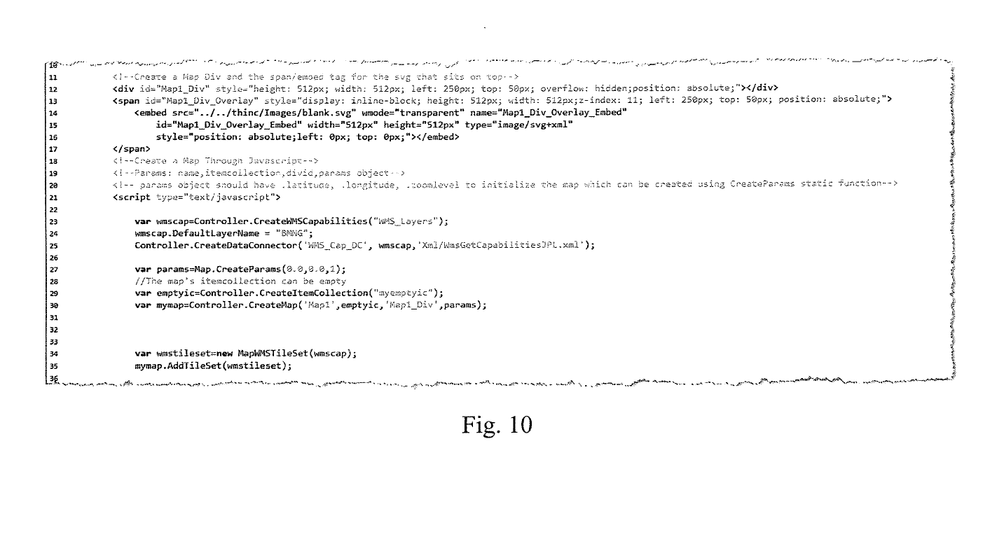

For each of the various views 110, 120, 130 and/or 160 and other graphical interface widgets within the thin or no client application 100, a corresponding XML tag is defined in the extended server tag library 4110, with parameters and default values enumerated as tag attributes. These XML tags are embedded in the web page inline with the regular HTML tags where the web page developer wants the graphical interface widget to appear. When a request identifying that web page is received by the server system 1000, that web page is processed on the server system 1000 to convert the web page to JavaScript. In particular, in this second exemplary embodiment, the thin or no client interface 4100 converts the XML tags into JavaScript code using the JavaScript Class Library 4120. FIG. 10 shows the JavaScript code that results when the HTML code fragment shown in FIG. 8 is converted using the thin client interface 4100.

Because the extended server tag library 4110 is implemented within the server system 1000, rich error checking and reporting is enabled. As the server system 1000 processes the requested web page to convert the HTML code into JavaScript code, any errors are trapped and recorded, and processing and validity checks are performed. When errors are encountered, detailed error messages are logged.

It should be appreciated that a class exists for each graphical interface widget. As the server system 1000 processes the HTML tags, an object model is constructed in code to mirror the tags. The thin client interface 4100 intercepts when the server system 1000 writes the content, and replaces the content from the server system 1000 with the appropriate JavaScript code. As the object model is being constructed in memory, the code validates the XML against the expected results. By doing this, the thin client interface 4100 is able to produce rich error messages and logs to aid the web page developer in development and debugging the web page that implements the thin or no client application 100.

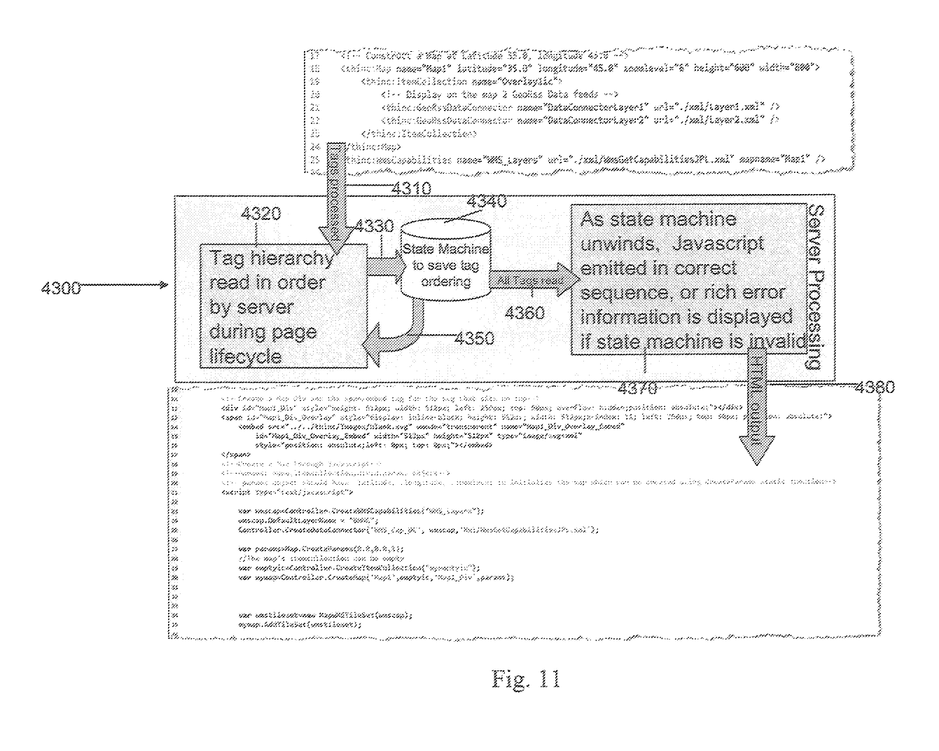

A variety of applications can be built on top of this JavaScript framework. At the heart of this JavaScript framework is the JavaScript class library 4120. JSP custom tags and ASPX custom tags, which are also referred to as .NET Web Controls, in the extended server tag library 4110 provide a programming abstraction layer on top of the JavaScript library 4120. As described herein, in the exemplary embodiment shown in FIG. 11, these custom tags in the web page are converted to the corresponding JavaScript using the thin client interface 4100 before the web page is returned to the requesting user. Thus, thin or no client applications 100 can be programmed using the JSP Custom Tags or .NET Web Controls for fast integration into existing web applications. Alternatively, thin or no client applications 100 can be programmed using the JavaScript API for optimal flexibility.

To process the HTML web page on the server system 1000, a state machine is constructed to monitor the page processing. This state machine pushes and pops items from an internal Stack data structure as the XML tags are processed. As the stack unwinds, the JavaScript code is emitted in the hierarchal sequence. FIG. 11 illustrates this process 4300. As shown in FIG. 11, each HTML tag is read in and processed by a tag processing process 4310. As each tag is read in and processed, it is pushed onto an internal stack data structure 4320 that maintains the order and nesting of the tags. Each tag is popped 4330 off the internal stack data structure 4320 in order and acted upon by a state machine 4340. The state machine 4340 converts the tags to the appropriate JavaScript code 4360 and, if necessary, pushes 4350 that tag back onto the stack 4320. The JavaScript code is analyzed 4370 to determine if there are any errors. If not, the JavaScript code is output as a new HTML web page 4380.

It should be appreciated that, in various exemplary embodiments, the extended server tags implemented in the server tag library 4110 of the thin client interface 4100 are exposed natively in the both the Windows IIS environment and the Linux Apache environment. This enables true cross-platform development, because the tag model is one-to-one compatible between these platforms. Thus, in such exemplary embodiments, if the extended server tags are coded within the Linux Apache environment, that code could be copied directly to a Windows IIS environment and behave the same as it would within the Linux Apache environment. To keep the mapping equivalent, some of the native Windows tag controls are masked and forced to behave the same as they do in Java. Consequently, in such exemplary embodiments, a web page created using JSP Custom Tags will run in the .NET environment, and vice versa. It should be appreciated that, in such exemplary embodiments, the extended server tag library 4110 exploits HTML's inherent notion of containment, such as, for example, ‘embedding’ map data sources within a <custom:map /> tag. In this way the complex underlying JavaScript is shielded from the end developer, enabling rapid prototyping and quick integration.

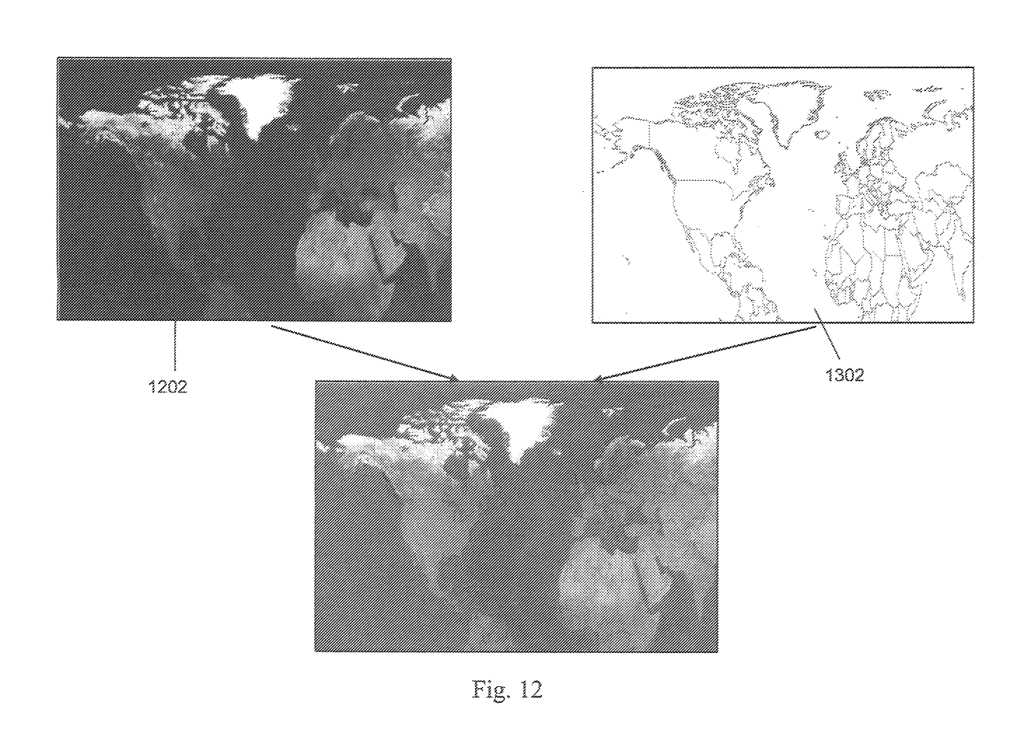

FIG. 12 show two sets of image data tiles returned to the thin or no client application 100 and the resulting content displayed in the image view 160 in response to executing the HTML code shown in FIG. 9. In particular, in the example shown in FIG. 12, the thin or no client application 100 combines the NASA satellite image data tiles 1202 with the feature data tiles 1302 showing political boundaries by laying the feature tiles 1302 over the satellite image tiles 1202 when displaying the image and feature data tiles 1202 and 1302 in the image view 160.

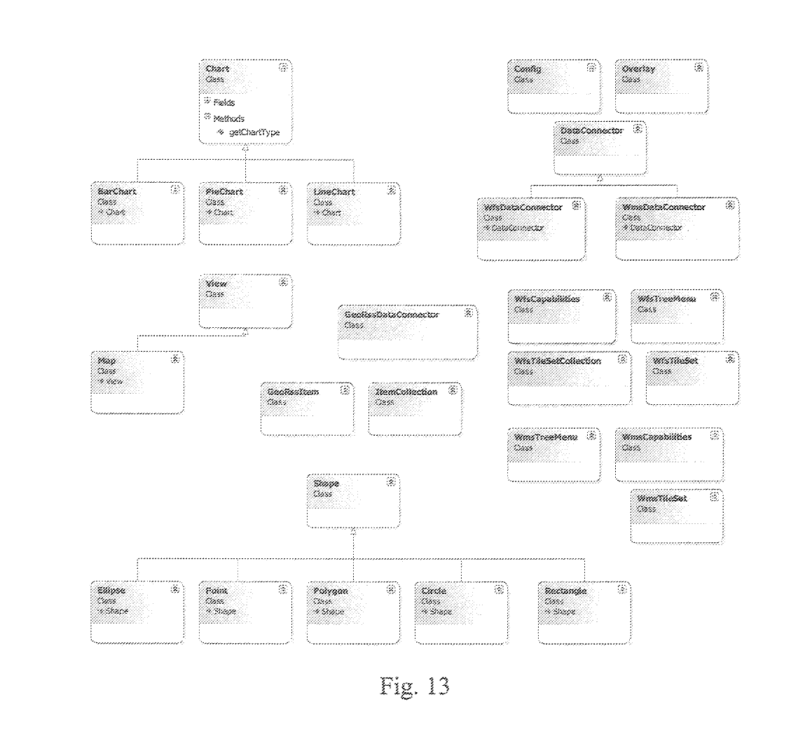

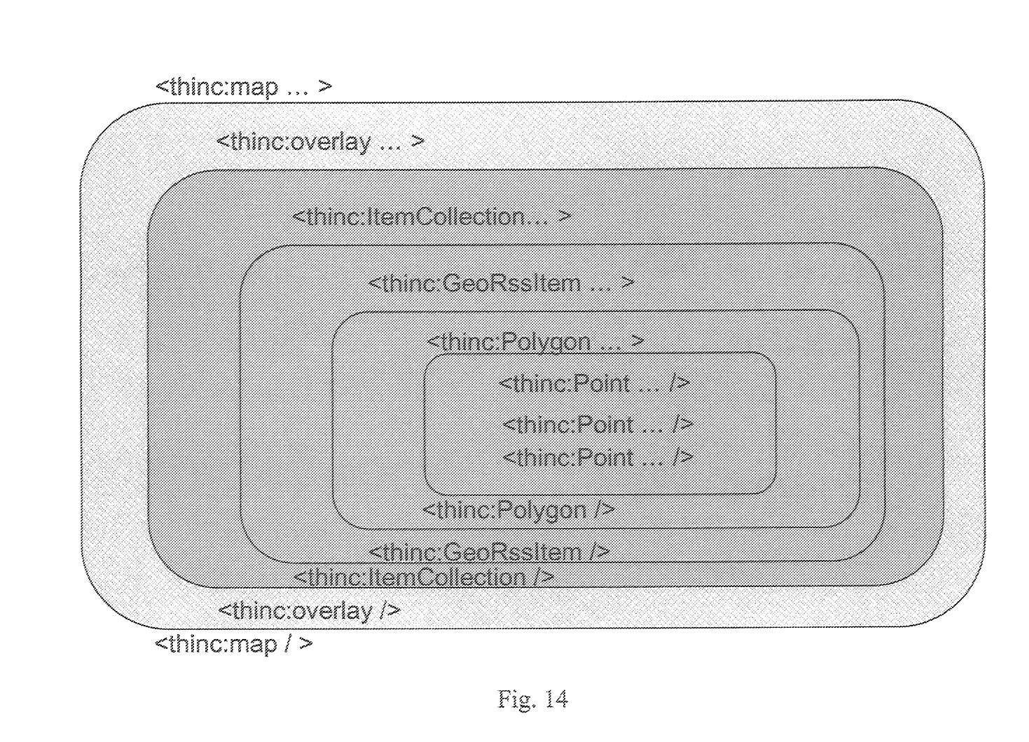

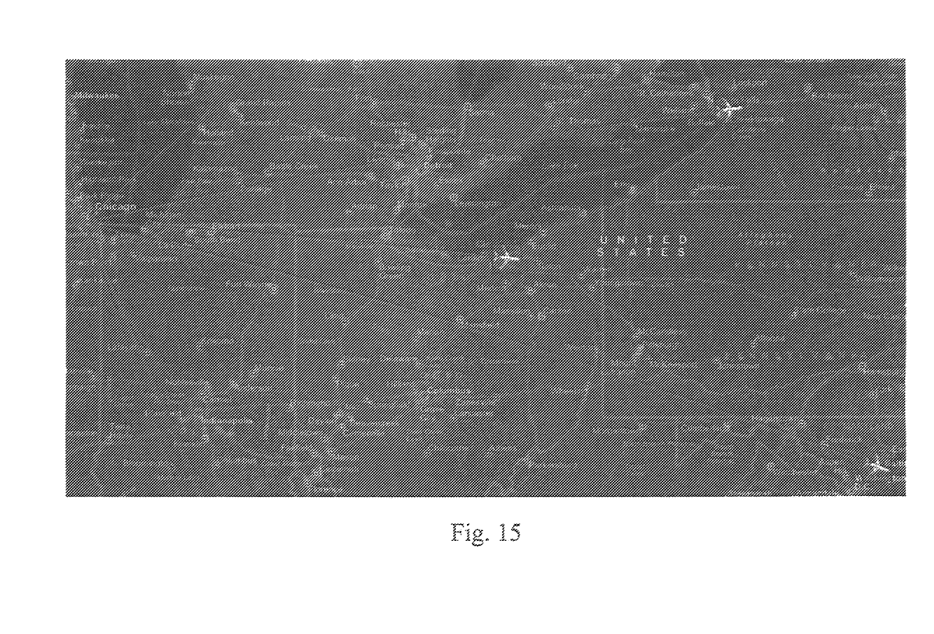

FIG. 13 illustrates one exemplary embodiment of the server tag object model for the extended server tags of the server tag library 4110. FIG. 14 illustrates how the server tags of the server tag object model shown in FIG. 13 are organized hierarchically, i.e., are nested.

It should be appreciated that JavaScript is an interpreted language, and thus is prone to errors arising from mistakes in typing. As a consequence, errors in the JavaScript program can only be detected through trial and error using the browser as a test client. To avoid user errors while programming against the classes, the object model is exposed as a set of XHTML tags. Exposing the methods in this way allows syntax checking and rudimentary IDE support like intellisense and highlighting of errors.

FIG. 7 also illustrates that the conversion services 4000 also includes the mobile services 4200. As is commonly known, screens on mobile devices are typically small, with the screen of each different mobile device have differing orientations and dimensions and have varying pixel resolutions. Thus, mobile devices require special attention. Additionally, mobile devices have typically slower processors, minimal battery life, and constrained local storage. These factors must be appreciated when integrating a mobile appliance into the server system 1000. Creating a compelling mobile client requires careful consideration of all these constraints. To fully take advantage of mobile applications, various exemplary embodiments of the server system 1000 have been extended to process and deliver data in new ways. By off-loading this processing from the mobile device to the server system 1000, the mobile device's resources can be conserved and the user's experience can be enhanced.

As indicated above, mobile devices have varying screen resolutions and physical dimensions. Some devices, such as for example, the Palm Treo, have a square screen with a pixel resolution of 320×320. Other smart-phones have rectangular dimensions, with orientations in both Landscape and Portrait. On the far end of the device scale, small handheld computer devices have screen resolutions of 800×600 with a physical dimension of 5″. Simply delivering “a standard set” of images to the mobile device clients and letting the mobile device handle the difference would be disastrous, since mobile devices generally do not have the processing power required for such intense image manipulation. Rather, in various exemplary embodiments, such as that shown in FIG. 7, the server system 1000 is extended to allow the image manipulation to be done by the server system 1000, which then passes on the requested images to the requesting mobile device at the resolution and dimensions that are specific to that mobile device.

It should be appreciated that, in a mobile device, the battery life is directly proportional to processor power and processor workload. If the web application is designed to have the mobile device to do heavy computations or image manipulation, the mobile device take a double hit, as this has the effect of slowing the device's overall performance, while simultaneously draining the battery. Battery life is at a premium in mobile devices, with manufactures trying to increase the battery power by continually reducing the processor power. Accordingly, in various exemplary embodiments, the server system 1000 serves images “pre-cooked” for the specific mobile device. This allows the device to simply display the received images, rather than needing to manipulate the images before the images can be displayed.

Current mobile technology delivers limited color depth and current mobile devices typically only display 24-bit color, as opposed to the 32-bit color standard used in most desktop display adaptors. This limits the ability of the server system 1000 to finely calibrate feature data points to the image tiles. In various exemplary embodiments, the mobile services 4200 allows the server system 1000 to accommodate the reduced color depth.

It should also be appreciated that typical mobile devices are designed to be used within 5″-6″ from the user's eyes. In contrast, desktop monitors are typically spaced 17″-25″ from the eyes. Additionally, some mobile devices are specifically designed with touch interfaces, such as, for example, the Windows Mobile platform, whereas other mobile devices are designed to use a stylus, such as, for example, the TabletPC. Fingertip use requires bigger icons with larger hotspots to be activated, while with stylus use, a smaller hotspot is possible. Some mobile devices, such as, for example, Smart Phones allow for neither, and rely on the telephone input digits or joysticks, such as, for example, the Blackberry pearl, for input. The mobile services 4200 includes algorithms and tolerances defined to allow varying sized hotspots depending on the particular mobile device. The larger hotspots require larger icons, so icon collision detection algorithms are implemented in the mobile services 4200 to space the hotspots accordingly.

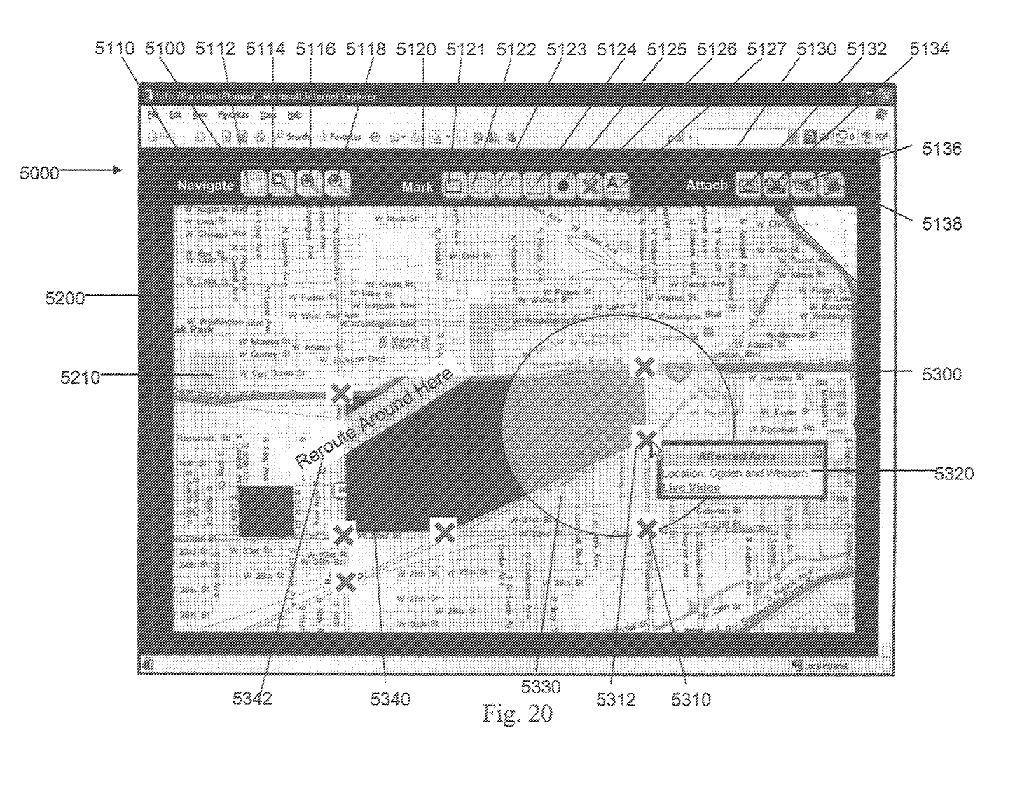

FIGS. 15-20 illustrated a variety of geospatial and spatially-oriented thin client web applications that are based on the thin client web application I 00 shown in FIG. 1 and that implement different types of tracking services and/or collaboration applications. There are three general types of tracking services. The first type has to do with showing where objects are and where the objects have been. The second type involves analytical calculations involving the object positions. The third type of feature involves real-time alerts. It should be appreciated that the collaboration application shown in FIG. 20 can be combined with any of these tracking services.

The first type of tracking service, positional and historical services, typically includes two different services: current position tracking and object path tracking. A current position tracking service returns the current position of each tracked object and attributes associated with object. This is essentially the most recent position of the object obtained from the collection system. An object path tracking service returns the position history of an object. FIG. 15 shows one exemplary image view 160 that displays an object path tracking service using the thin client web application 100 according to this invention.

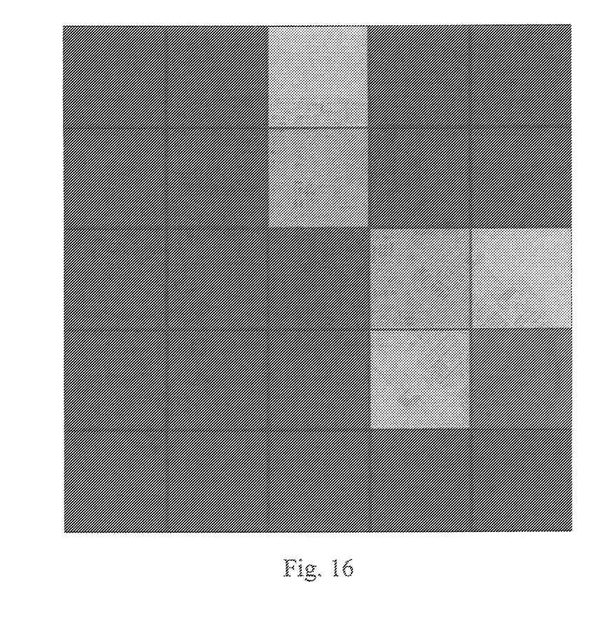

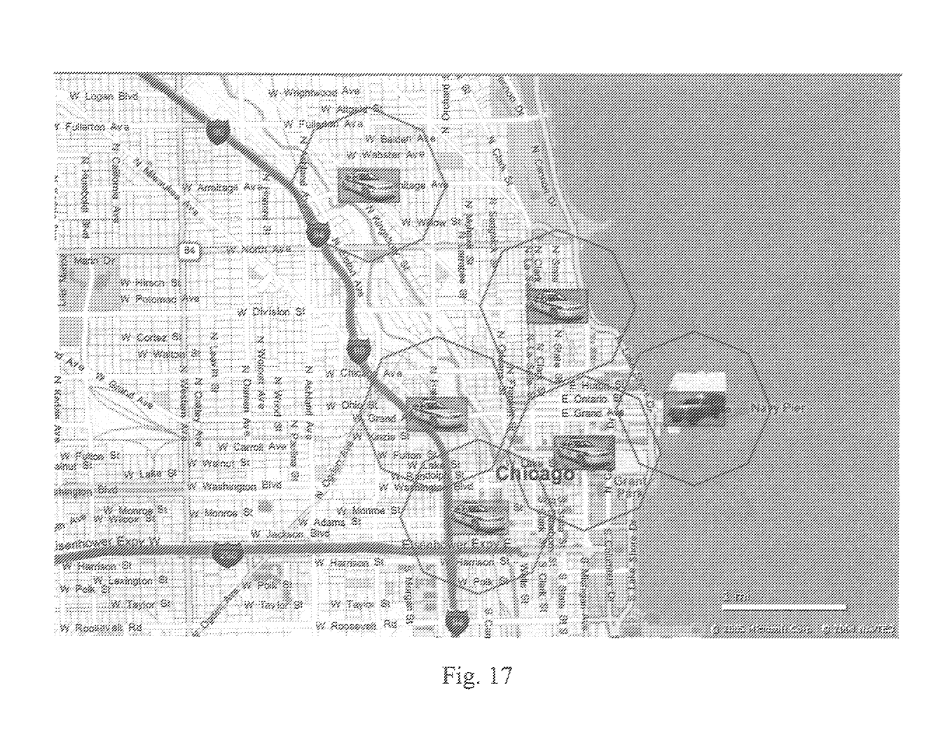

The second type of tracking service, analytical services, typically includes a number of different services, including: area of influence tracking services; location metrics tracking services; heat map tracking services; location prediction tracking services; and geospatial relationships tracking services. As shown in FIG. 16, the heat map tracking services for a set of objects provides a measurement of each objects position in grid cells within a geospatial or spatially-oriented region. The area of influence tracking services returns regions that are within close proximity to an object. For example, as shown in FIG. 17, in a police or first responders application, this might be any region within five minutes driving distance of a squad car. The location metrics tracking services calculates the amount of time that objects spend in areas and other geospatial regions of interest. The location Prediction tracking services applies analytical routines to extrapolate, from an object's historical trends and current position, a prediction of its position at a future point in time. The geospatial relationships tracking services identifies relationships among movement patterns of the objects, such as, for example, identifying which objects move together and which stay separated.

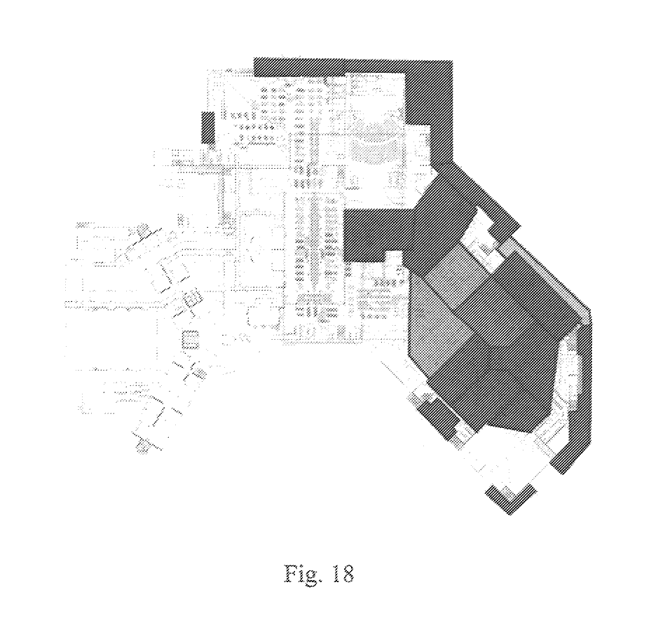

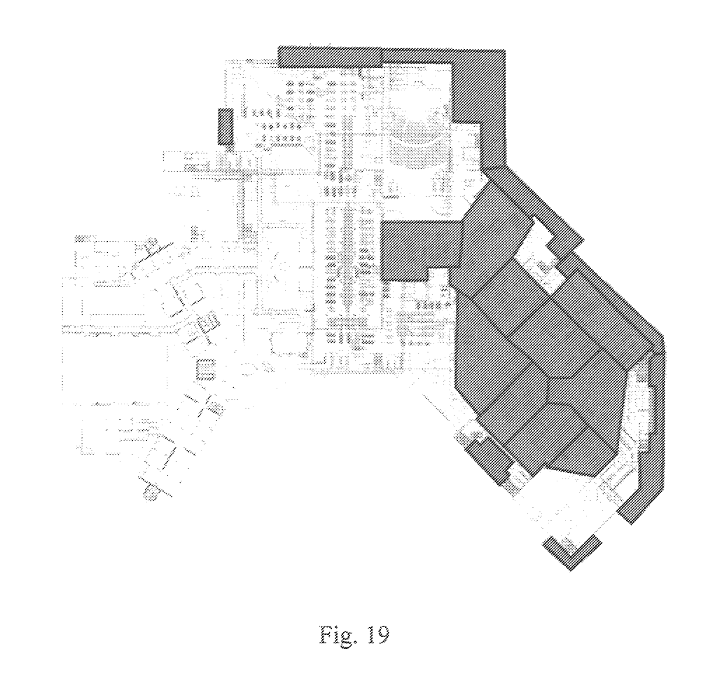

The third type of tracking service, alerting services, typically includes a number of different services, including geo-fencing services. The geo-fencing services enable users to specify regions of interest and then trigger alerts when objects enter or leave the geo-fenced regions. This service constantly monitors the positions of objects. FIGS. 18 and 19 show two exemplary geo-fencing applications.

As outlined above with respect to FIGS. 2 and 7, in various exemplary embodiments, the thin or no client application 100 can be a GPS or RFID tracking application 3400. In such exemplary embodiments, the image view 160 would display an image representing the area that one or more persons or things are tracked. For example, in the exemplary embodiment shown in FIG. 15, the things being tracked are airplanes, and the area over which they are being tracked is represented by a geospatial map image.

In this exemplary embodiment, the data services 1500 of the server system 1000 shown in FIGS. 2 and 7 ingests tracking data from one of the business and other data sources 2300 that receives location and time data. In this exemplary embodiment, the location and time data would be generated by a government flight data center that generates location and time data for each plane from transponders carried by each plane. The tracking server 1610 of the application services 1600 shown in FIGS. 2 and 7 receives XML and/or RSS data requests from the tracking application 3400. Typically, these requests indicate the geospatial area currently displayed in the image view 160. In response, the tracking server 1610 passes the request to the data services, which requests the desired data from the appropriate one(s) of the data sources 2300. The data services 1500 compiles the requested data for the geospatial area shown in the image view 160 and returns that data to the tracking server 1610.

The tracking server 1610 processes the data returned by the data services 1500 to generate an XML or RSS data stream comprising a plurality of objects, defined using SVG or other object rendering language, that represent the paths and current locations of the objects being tracked that are currently located in the geospatial area shown in the image view 160 or that recently passed through that geospatial area. These objects can also include icons that represent the airplanes and associated tooltip boxes that, when the associated plane is selected, give relevant information about that airplane, such as flight number, organization, altitude, heading, destination, or the like.

In the exemplary embodiment shown in FIG. 16, the things being tracked are people and/or items in a building, such as a factory or other commercial establishment. In this exemplary embodiment, the image view 160 displays a floor plan as one or more image tiles and a plurality of feature tiles that represent sections of the floor plan. In various exemplary embodiments, the color of each tile represents, for a single person or thing that is being tracked, whether and how recently that person or thing was present in the portion of the building that lies within the bounds of that feature tile. In particular, if the person or thing was not within the portion of the building that lies within the bounds of a given feature tile within the relevant time frame, that feature tile is colored blue. If the person or thing is currently within the portion of the building that lies within the bounds of a given feature tile, that feature tile is colored dark red. If the person or thing is not currently within the portion of the building that lies within the bounds of a given feature tile, but has been within the relevant time frame, that feature tile is colored pink or grey, depending on how recently that person or thing was in that portion of the building.

It should be appreciated that, in other exemplary embodiments, the color coding of the tiles can be a function of any metric that can be obtained by analyzing the tracking data. Thus, in various exemplary embodiments, the tiles can be colored based on the density of tracked RFID tags within each tile. In this case, areas in the floor plan where there is a high density of the tracked RFID tags will have the corresponding tiles colored red, areas in the floor plan where there is a low density of the tracked RFID tags will have the corresponding tiles colored blue, and areas in the floor plan where there is an intermediate density of the tracked RFID tags will have the corresponding tiles colored pink or white. The metrics that can be obtained by analyzing the tracking data is limited only by the types of data that are associated with the RFID tags.

In this case, the tracking server 1610 of the application services 1600 shown in FIGS. 2 and 7 receives an XML and/or RSS data request from the tracking application 3400 regarding the tracking data for a specific person or thing. In response, the tracking server 1610 passes the request to the data services, which requests the desired data from the appropriate one(s) of the data sources 2300. The data services 1500 compiles the requested data for the location shown in the image view 160 and returns that data to the tracking server 1610. The data services 1500 also accesses one of the business data sources 2300 that defines the relevant time frame for the person or thing being tracked.

The tracking server 1610 processes the data returned by the data services 1500 to generate an XML or RSS data stream that includes a plurality of feature tiles, as disclosed above, or that comprises a plurality of objects, defined using SVG or other object rendering language, that represent the feature tiles. Based on tracking data and the business logic that defines the relevant time frame, the different number of time frames and the sizes and locations of the tiles, the tracking server 1610 determines the color for each tile.

In the exemplary embodiment shown in FIG. 17, the things being tracked are emergency service providers or first responders, such as police cruisers, ambulances and the like. The area over which these things are being tracked is represented by a geospatial map image displayed in the image view 160, which, in this exemplary embodiment, is a portion of a road map of Chicago.

In this exemplary embodiment, the data services 1500 of the server system 1000 shown in FIGS. 2 and 7 ingests tracking data from one of the business and other data sources 2300 that receives, location and time data from each of the emergency service providers. In this exemplary embodiment, the location and time data would be generated by GPS transceivers associated with each emergency service provider. The GPS transceivers receive GPS signals that allow the GPS transceiver to determine its geospatial location. The GPS transceiver then transmits the determined geospatial location and a time stamp to a data source 2300 that stores that data.

tracking server 1610 of the application services 1600 shown in FIGS. 2 and 7 receives XML and/or RSS data requests from the tracking application 3400 shown in FIG. 17. Typically, these requests indicate the geospatial area currently displayed in the image view 160. In response, the tracking server 1610 passes the request to the fusion services 1510, which requests the desired data from the appropriate one(s) of the data sources 2300. The data services 1500 compiles the requested data for the geospatial area shown in the image view 160 and returns that data to the tracking server 1610. The data services 1500 also ingests data logic that indicates, for each tracked emergency service provider, based on the time of day and the determined location, a likely area that the emergency service responder can reasonably respond to.

The fusion server 1510 of the data services 1500 is a flexible service that is able to ingest, manipulate, and publish geospatial and other spatially-oriented data so that it is usable by the server system 1000. The fusion server 1510 can connect to disparate data sources, schedule information pulls from each such data source, normalize the information, apply business rules, apply transformations, and then publishes the resulting data product as an XML feed. In various exemplary embodiments, the fusion server 1510 uses a provider pattern that implements an abstraction layer between the elements of the fusion server 1510 and the external data sources. This design pattern prevents changes in data feeds from rippling through and causing problems in the fusion server 1510.

The fusion server 1510 is able to pull data from web services, flat files, database, legacy systems, and customer formats. The fusion server 1510 can ingest WFS feature data, geospatial reference data, and map overlay information. FIG. 15 shows one exemplary embodiment of the elements of the fusion server 1510. By scheduling tasks using the request handler, the fusion server 1510 can handle real-time data that changes constantly, semi-static data that changes daily or weekly, and static data that changes infrequently. To achieve flexibility in its operation, the fusion server 1510 uses loose coupling between the business rules, interface code libraries, and request so that the capability might be used in arbitrary ways depending on the need. The loose coupling provides the flexibility needed to allow for custom normalization and business rule enforcement.

In various exemplary embodiments, the fusion server 1510 comprises four main parts. These four main parts include: 1) interface (i.e., data ingestor or extractor) modules, 2) a request/service configuration database; 3) a web administrative interface; and 4) the request handler. The interface modules implement the provider pattern to connect to various data sources and kept in an interface code library. These compiled C# modules are interrogated at run time using reflection and automatically bind into the data extraction engine of the fusion server 1510. These ingestor modules implement the provider pattern and enable the fusion server 1510 to connect to different data sources. It would normally be expected that the fusion server 1510 would need one specifically-designed ingestor module for each different data source that the fusion server 1510 ingests data from. However, because an ingestor module for a new data source can be readily added to the fusion server 1510, the fusion server 1510 is readily extensible, and does not require wholescale rewriting to allow such new data sources to be incorporated into the server system 1000.

In effect, with respect to the fusion server 1510, the ingestor modules are “plug and play”. That is, the interface of each ingestor module is metaphorically “cut in the exact same shape”. When the fusion server 1510 needs to ingest data that is in a new format, it becomes simple to add a new ingestor module, in place of or in addition to, the current ingestors modules, since the new ingestor module “is cut the same way”, so it is guaranteed to integrate into the fusion server 1510. In effect, while there are multiple ingestor modules, each module looks the same to the fusion server 1510, as their interfaces are indistinguishable. This allows the fusion server 1510 to add any necessary or desirable ingestor module and know that it will behave in the same way as any other ingestor module.

The request/service configuration database stores logic describing which sources to query, in what order, how to apply normalization and business rules, and which transformations to use. The web administrative interface is used to configure the system. The request handler, which can also be referred to as the fusion data engine, implements the fusion data service. This process runs as a service which responds to fusion data requests. This process will also invoke requests based on the time they are to run, and provides an automated way to ingest and publish information.

The tracking server 1610 processes the data returned by the data services 1500 to generate an XML or RSS data stream comprising a plurality of icons, defined using SVG or other object rendering language, that represent the current locations of the emergency service providers being tracked that are currently located in the geospatial area shown in the image view 160 and other objects that represent the bounds of the response areas for each of the emergency service providers. These objects can also include associated tooltip boxes that, when the associated icon is selected, give relevant information about that emergency service provider, such as number, organization, heading, current destination, if any, current status, such as whether it is already responding to an emergency service call, or the like. Using this information, a dispatcher or the like using this tracking application can readily determine which emergency service provider to dispatch in response to a new emergency.

In this exemplary embodiment, the tracking server 1610 applies analytic logic to the time and location data to determine the response area or area of influence of each emergency service provider. For example, an emergency service provider located within the Loop during rush hour will have a much different ability to respond, and thus will have a much smaller response area or area of influence than an emergency service provider located in a residential area between midnight and 5am. The analytic logic applies such types of logical rules to determine the response area or area of influence. In other types of tracking applications 3400, other types of analytic logic and logical rules will be applied.

The tracking services 1610 can also be used to implement alerting services for a particular tracking application 3400. In the exemplary embodiments shown in FIGS. 18 and 19, the things being tracked are people or physical assets, where the differently colored areas of the floor plans shown in FIGS. 18 and 19 represent different access rights. For example, in FIG. 18, the different colors can represent different levels of security or access, where white represents no security, blue represents low security, brown represents medium security and red represents high security. Each person in the building carries an RFID tag, with a security level associated with each RFID tag.

In this exemplary embodiment, the data services 1500 of the server system 1000 shown in FIGS. 2 and 7 ingests tracking data from one of the business and other data sources 2300 that receives location and time data for each of the RFID tags. In this exemplary embodiment, the location and time data would be generated as the persons pass by RFID tag readers. The RFID tag readers then transmits their location within the building and a time stamp when a particular RFID tag was read by that RFID tag reader to a data source 2300 that stores that data.

The tracking server 1610 of the application services 1600 shown in FIGS. 2 and 7 receives XML and/or RSS data requests from the tracking application 3400 shown in FIG. 18. Typically, these requests indicate the location displayed in the image view 160. In response, the tracking server 1610 passes the request to the fusion services 1510, which requests the desired data from the appropriate one(s) of the data sources 2300. The data services 1500 compiles the requested data for the geospatial area shown in the image view 160 and returns that data to the tracking server 1610. The data services 1500 also ingests data logic that indicates, for each tracked RFID tag, the security access associated with that tag.

In this alert tracking application, the user is only concerned with violations of the security access rights associated with a particular RFID tag. Thus, the tracking server 1610 processes the data returned by the data services 1500 to generate an XML or RSS data stream comprising a plurality of icons, defined using SVG or other object rendering language, that represent any RFID tag that is in an area for which that RFID tag does not have access rights. These objects can also include associated tooltip boxes that, when the associated icon is selected, give relevant information about that RFID tag, such as the person it is associated with, that person's organization, that persons security access level and the like. Using this information, a person using this tracking application can readily determine when someone has entered an area for which that person does not have access rights.

In contrast, in the example shown in FIG. 19, the different colors can represent different areas that a physical asset, such as a slot machine in a casino, is allowed to be in. In this example, the brown areas represent areas of the casino where the slot machine is permitted, such as the casino floor. The gray areas represent areas where the slot machine may be moved to under a work order or the like, such as a maintenance shop, a store room and other permitted areas. In contrast, the white areas represent areas where the slot machine should not be present. By attaching an RFID tag to each slot machine, the real-time location of each slot machine within the casino can be determined.

In this exemplary embodiment, the data services 1500 of the server system 1000 shown in FIGS. 2 and 7 ingests tracking data from one of the business and other data sources 2300 that receives location and time data for each of the RFID tags. In this exemplary embodiment, the location and time data would be generated as each RFID tag on the slot machines are scanned by an RFID tag reader. The RFID tag readers then transmits their location within the building and a time stamp when a particular RFID tag was read by that RFID tag reader to a data source 2300 that stores that data.

The tracking server 1610 of the application services 1600 shown in FIGS. 2 and 7 receives XML and/or RSS data requests from the tracking application 3400 shown in FIG. 19. Typically, these requests indicate the location displayed in the image view 160. In response, the tracking server 1610 passes the request to the fusion services 1510, which requests the desired data from the appropriate one(s) of the data sources 2300. The data services 1500 compiles the requested data for the geospatial area shown in the image view 160 and returns that data to the tracking server 1610. The data services 1500 also ingests data logic that indicates, for each tracked RFID tag, where that RFID tag is supposed to be.

In this alert tracking application, the user is only concerned when a slot machine associated with a particular RFID tag is not in the location it is supposed to be in. Thus, the tracking server 1610 processes the data returned by the data services 1500 to generate an XML or RSS data stream comprising a plurality of icons, defined using SVG or other object rendering language, that represent any RFID tag that is in an area that is not in an area where it is supposed to be. These objects can also include associated tooltip boxes that, when the associated icon is selected, give relevant information about that RFID tag, such as the slot machine it is associated with, where that slot machine is supposed to be and the like. Using this information, a person using this tracking application can readily determine when someone has improperly moved a slot machine, such as when attempting to steal the slot machine.

Another potential tracking application uses RFID tags or the like that are assigned to employees. When the employee clocks in for a work shift, the employee also has their RFID tag read. When the employee enters the work floor, such as a casino floor, a factory floor or the like, another RFID tag reader records when the employee enters the work floor. Business logic rules can define the permissible time gap that the employee is allowed between when the employee clocks in and when the employee enters the work floor. A supervisor using a thin or no client tracking application that implements this business logic rule and ingests such RFID tracking information can be supplied with alerts when an employee has clocked in but fails to enter the work floor within the permitted time.

Such alerts can be generated when the employee enters the work floor, or when the employee passes by the next RFID tag reader after the permitted time has expired. Such an alert can include an icon displayed in a floor plan of the commercial site shown in an image view 160 of a thin or no client application 100. Additional information, such as that indicating the employee's identity and current location, the time the employee clocked in, the time the employee entered the work floor, the employee's track after clocking in, and the like, can also be displayed. It should be appreciated that various business logic rules can be applied to tracking information to control any appropriate business activity, such as, for example, employee presence, location of equipment and supplies, and the like.

FIG. 20 illustrates one exemplary embodiment of a thin or no client application 5000 that includes a collaboration tool bar 5100. As shown in FIG. 20, the thin or no client application 5000 has an image view 5200 that displays a map image 5210 and a number of collaboration objects 5300 created by the user of the thin or no client application 5000. These collaboration objects 5300 are sent by the thin or no client application 5000 to the collaboration server 1620 of the application services 1600 as they are created by the user of the thin or no client application 5000. The collaboration server 1620 asynchronously streams these collaboration objects back out to other instances of the thin or no client application 5000. These collaboration objects allow one user of the thin or no client application 5000 to convey information to and receive information from, and thus engage in collaborative activities with, other users of the thin or no client application 5000.

As shown in FIG. 20, the collaboration toolbar 5100 includes a number of navigation toolbar widgets 5110, a number of marking toolbar widgets 5120 and a number of attachment toolbar widgets 5130. It should be appreciated that the various widgets 5110, 5120 and 5130 implemented in the collaboration toolbar 5100 are not limited to those shown in FIG. 20. Thus, it should be appreciated that, in various other exemplary embodiments, various other combinations of the collaboration widgets shown in FIG. 20 and/or any other appropriate collaboration widgets can be included in a particular instance of the collaboration toolbar 5100.

The navigation toolbar widgets 5110 allow the user to navigate within the image 5210 displayed in the image view 5200 and include a grab widget 5112, a zoom selection widget 5114, a zoom in widget 5116, and a zoom out widget 5118. These widgets have the standard functionality typically associated with such widgets.

The marking toolbar widgets 5120 allow the user to add annotation marks and other collaborative information to the image 5210. In the exemplary embodiment of the collaboration toolbar 5100 shown in FIG. 20, the marking toolbar widgets 5120 include a rectangle object drawing widget 5121, an ellipse object drawing widget 5122, a line object drawing widget 5123, a polygon object drawing widget 5124, a point object drawing widget 5125, an X object drawing widget 5126, and a text box drawing widget 5127. The rectangle object drawing widget 5121 is usable to draw a rectangular object over the image 5210. The ellipse object drawing widget 5122 is usable to draw an elliptical object over the image 5210, such as the circular object 5330. The line object drawing widget 5123 is usable to draw a line object over the image 5210. The polygon object drawing widget 5124 is usable to draw a polygonal object over the image 5210, such as the polygonal region 5240. The point object drawing widget 5125 is usable to draw a point object over the image 5210. The X object drawing widget 5126 is usable to draw a “X marks the spot” object over the image 5210, such as the X objects 5310 and 5312. The textbox drawing widget 5127 is usable to draw a text box object over the image 5210, such as the text box 5342.

The attachment toolbar widgets 5130 are usable to attach various files and feeds to the other collaboration marks drawn on the image 5210 shown in the image view 5200 of the thin or no client application 5000. As shown in FIG. 20, in various exemplary embodiments, the attachment toolbar widgets 5130 include an attach picture widget 5132, an attach recording widget 5134, an attach video widget 5136, and an attach notes widget 5138. The attach picture widget 5132 is usable to attach a still picture to another one of the collaboration marks drawn on the image 5210. The attach recording widget 5134 is usable to attach an audio recording or a live audio feed to another one of the collaboration marks drawn on the image 5210. The attach video widget 5136 is usable to attach a video recording or live video feed to another one of the collaboration marks drawn on the image 5210. The attach notes widget 5138 is usable to attach a tooltip or other pop-up note to another one of the collaboration marks drawn on the image 5210.

It should be appreciated that, as shown in FIG. 20, the attach picture widget 5132, the attach recording widget 5134 and/or the attach video widget 5136 can be used to attach a still picture, an audio file or feed and/or a video file or feed into the note 5320. As shown in FIG. 20, mousing over, selecting or otherwise interacting with one of the collaboration marks, such as the X mark 5312, can cause a note mark, such as the note mark 5320, that is associated with that collaboration mark to pop up.

It should be appreciated that, in various exemplary embodiments, the collaboration marks are SVG or other objects defined in an object rendering language. Thus, the collaboration marks can be handled by the collaboration server 1620 in the same way that other SVG objects or the like are handled by the server system 1000. The incorporated 700 Provisional Patent Application discuss another exemplary collaboration embodiment in greater detail.

It should be appreciated that the specific examples of tracking applications and collaboration applications outlined above with respect to FIGS. 15-20 are intended to be illustrative only. The types of tracking applications 3400 are unlimited and depend on the types of things or persons being tracked, the data associated with the GPS receiver or RFID tag for each item, the tracking data recorded by the tracking source, and the analytic logic rules associated with the tracking application 3400. Similarly, the types of collaboration applications are unlimited and depend on the types of underlying thin or no client applications 100 and/or 3000 and the particular collaboration widgets implemented in a particular collaboration toolbar 5100.

It should be appreciated that the above-outlined various exemplary embodiments of systems and methods according to this invention extends the concept of “mashups” to spatial images beyond maps, such as, for example, factory floors and other spaces, and beyond spatial images to any image data where location information is present or can be defined, such as medical images and other images. It should further be appreciated that the above-outlined various exemplary embodiments of systems and methods according to this invention extends the concept of “mashups” to multiple datasources and multiple different layers of maps and/or other image data, such as, for example, a topological map layered on a geospatial image taken from a airplane and/or different layers of other data, such as, for example, layers of feature data and/or layers of non-spatial data. For example, a “layer” of non-spatial data can be alert data. For example, if one of the business or analytic rules is “5 minutes after you punch in, you must be on the work floor”, a tracking server for this tracking application will monitor the punch clock. If the employee RFID tag is not on the floor in 5 minutes, an alert is sent to the manager which is displayed using a thin or no client tracking application executing on the manager's mobile device. The business or analytic rules are defined in a business/workflow server.

While this invention has been described in conjunction with the exemplary embodiments outlined above, various alternatives, modifications, variations, improvements and/or substantial equivalents, whether known or that are or may be presently foreseen, may become apparent to those having at least ordinary skill in the art. Accordingly, the exemplary embodiments of the invention, as set forth above, are intended to be illustrative, not limiting. Various changes may be made without departing from the spirit or scope of the invention. Therefore, the invention is intended to embrace all known or earlier developed alternatives, modifications, variations, improvements and/or substantial equivalents.

1. A server system that receives data requests from a client and that asynchronously streams requested data to the client, comprising:
an image services portion that receives image data requests from the client, comprising at least one of:
a map services portion that, in response to image data requests for raster image data, obtains the requested raster image data from a data source, converts the obtained raster image data from a native format of that data to a first predetermined format, and streams the converted raster image data in the first predetermined format to the requesting client, and
a feature services portion that, in response to image data requests for feature vector data, obtains the feature vector a data source that stores the requested feature data and streams the requested feature data to the requesting client in one of the first predetermined format and a second predetermined format;
an application services portion that receives data requests from the client, comprising at least one of:
a tracking server that receives tracking data requests from the client and, in response to a tracking data request, obtains tracking data for tracked entities and supplies the obtained tracking data to the requesting client; and
a collaboration server that receives collaboration information from a first one of a plurality of clients and that streams the received collaboration information to other ones of the plurality of clients.

2. The server system of claim 1, wherein the image services renders feature data onto feature image tiles and streams the rendered feature data to the client as raster image feature tiles.

3. The server system of claim 1, further comprising a data services portion, wherein:
the tracking data request identifies at least one object to be tracked;
the data services portion ingests tracking data from at least one tracking data source based on the received tracking data request and compiles the ingested tracking data and outputs the compiled tracking data to the tracking server, and
the tracking server processes the compiled tracking data received from the data services portion to generate a data stream that is in a predefined format that is tuned for the client and that is supplied to the requesting client the supplied tracking data.

4. The server system of claim 3, wherein:
the data services portion includes an extensible set of data ingester modules, each data ingester module using a same interface and usable to ingest data from a data source in a native format specific to that data ingester module, that data ingester module converting the data in that specific native format into a common format usable by tracking server; and
when the tracking server needs to ingest data from a data source that provides data in a different native format that is not supported by any current data ingester module of the extensible set of data ingester modules, a new data ingester module that uses that same interface and that is usable to ingest data in the that different native format can be added to the extensible set of data ingester modules.

5. The server system of claim 1, wherein the image services provides a WMS-compatible interface.

6. The server system of claim 5, wherein the image services provides a WFS GetCapabilities-like interface such that the client is able to determine what feature data is available.

7. The server system of claim 1, wherein:
at least one of the map services portion, the feature services portion and the application services portion includes an extensible data ingester portion, the extensible data ingester portion comprising a plurality of data ingester modules, each data ingester module using a same interface and usable to ingest data from a data source in a native format specific to that ingester module, that data ingester module converting the data in that specific native format into a common format usable by other portions of the one of the map services portion, the feature services portion and the application services portion that includes that extensible data ingester portion; and
when one of the map services portion, the feature services portion and the application services portion of the server system needs to ingest data from a data source that provides data in a different native format that is not supported by any current data ingester module of the extensible data ingester portion of that one of the map services portion, the feature services portion and the application services portion, a new data ingester module that that uses that same interface and that is usable to ingest data in the that different native format can be added to that extensible data ingester portion.

8. A server system that receives data requests from a client and that asynchronously streams requested data to the client, comprising:
a raster data services portion that, in response to image data requests that include requests for raster image data, streams the requested raster image data in a first predetermined format to the requesting client, and
a feature data services portion that, in response to image data requests that include requests for feature image data, streams feature vector image data in one of the first predetermined format and a second predetermined format to the requesting client as the requested feature image data.

9. The server system of claim 8, wherein the raster data services portion comprises:
a map servlet portion that receives an image data request from the client, the image data request identifying requested image data, and that asynchronously streams the requested image data to the client in the first predetermined format;
a data extractors portion that includes at least one data extractor, each data extractor adapted to receive an image data request from the map servlet portion, locate the requested image data in an associated image data source, receive the requested image data from the associated data source if the associated data source stores the requested image data and convert the received requested image data from a native format to a defined format; and
a data handlers portion that includes at least one data handler, the at least one data handler converting the retrieved image data from the defined format into the first predetermined format and providing the retrieved image data in the first predetermined format to the map servlet portion.

10. The server system of claim 9, wherein:
the data extractors portion includes an extensible set of the at least one data extractor, each data extractor using a same interface; and
when the data extractors portion needs to ingest data from a data source that provides data in a different native format that is not supported by any current data extractor of the extensible set of data extractors, a new data extractor that uses that same interface and that is usable to ingest data in the that different native format can be added to the extensible set of data extractors.

11. The server system of claim 9, wherein the at least one data handler comprises at least one of a preprocessed image archive handler and at least one ingest handler.

12. The server system of claim 9, further comprising a data cache, wherein the map servlet portion queries the data cache to determine if image data in the first predetermined format corresponding to the requested image data is already present in the data cache, and, if so, receives the stored image data from the data cache and asynchronously streams the stored image data to the client as the requested image data to the client in the first predetermined format.

13. The server system of claim 8, wherein the feature data services portion comprises:
a feature servlet portion that receives a feature data request from the client, the feature data request identifying requested feature data, and that asynchronously streams the requested feature data to the client in one of the first predetermined format and the second predetermined format;
a data handler portion that comprises at least one data handler, each data handler adapted to receive a feature data request from the feature servlet portion, locate the requested feature data in an associated image data source, receive the requested feature data from the associated data source if the associated data source stores the requested feature data and convert the received requested feature data from a native format to the second predetermined format, where in the data handler portion provides the received requested feature data in the second predetermined format to the feature servlet; and
an image generator portion that receives the received requested feature data in the second predetermined format, converts the received requested feature data from the second predetermined format to the first predetermined format, and provides the received requested feature data in the first predetermined format to the feature servlet;

14. The server system of claim 13, further comprising a data cache, wherein, when the feature servlet streams the requested feature data to the client in the first predetermined format, the feature servlet portion queries the data cache to determine if feature data in the first predetermined format corresponding to the requested feature data is already present in the data cache, and, if so, receives the stored feature data from the data cache and asynchronously streams the stored feature data to the client as the requested feature data to the client in the first predetermined format.

15. The server system of claim 13, wherein, when the feature servlet streams the requested feature data to the client in the first predetermined format, the image generator portion receives the received requested feature data in the second predetermined format from the data handler portion, converts the received requested feature data from the second predetermined format to the first predetermined format and provides the received requested feature data in the first predetermined format to the feature servlet and the feature servlet asynchronously streams the feature data received from the image generator to the client as the requested feature data to the client in the first predetermined format.

16. The server system of claim 13, wherein, when the feature servlet streams the requested feature data to the client in the second predetermined format, the data handler portion provides the received requested feature data in the second predetermined format to the feature servlet and the feature servlet asynchronously streams the feature data received from the data handler portion to the client as the requested feature data to the client in the second predetermined format.

17. The server system of claim 8, wherein the server system further receives requests for a web page from the client, the web page comprising a plurality of instructions for asynchronously requesting image data, parsing the requested image data and displaying the parsed image data without a need for any additional client-side software entities to be installed on the processing device, the instructions stored in the web page in a first language, the server system further comprising a conversion services portion usable to convert the web page in the first language into a second web page that is in a second language, the conversion services receiving the requested web page in the first language, generating the second web page in the second language, and providing the second web page in the second language to the requesting client as the requested web page.

18. The server system of claim 8, further comprising a tracking services portion that receives a tracking data request from the requesting client, the tracking data request identifying a spatial area, wherein the tracking services portion obtains tracking data from a tracking data source for at least one tracked item located within the identified spatial area; and asynchronously transmits at least a portion of the tracking data to the requesting client.

19. The server system of claim 8, further comprising a tracking services portion that receives a tracking data request from the requesting client, the tracking data request identifying a spatial area, wherein the tracking services portion obtains tracking data from a tracking data source for at least one tracked item located within the identified spatial area; analyzes the tracking data with respect to at least one analytic rule, generates at least one alert based on the analysis and asynchronously transmits at least the at least one alert to the requesting client.

20. The server system of claim 8, further comprising a tracking services portion that receives a tracking data request from the requesting client, the tracking data request identifying a spatial area, wherein the tracking services portion obtains tracking data from a tracking data source for at least one tracked item located within the identified spatial area; analyzes the tracking data with respect to at least one analytic rule, generates at least one feature data object based on the analysis and asynchronously transmits at least the at least feature data object to the requesting client.

21. The server system of claim 8, further comprising a collaboration services portion that receives collaboration data from a first client relative to a first set of data, the collaboration services asynchronously forwarding the collaboration data received from the first client to any other client that has received the first set of data.

22. The server system of claim 8, wherein the server system further comprises a conversion services portion that implements a library of hierarchically-related server tags that expose an object model as a relationship of nested tags, such that hierarchically-inferior server tags are contained within hierarchically-superior tags, each hierarchically-inferior tag supplying data to a hierarchically-superior tag that contains that hierarchically-inferior tag.

23. The server system of claim 22, wherein the server system further receives requests for a web page from the client, the web page comprising a plurality of instructions for asynchronously requesting image data, parsing the requested image data and displaying the parsed image data without a need for any additional client-side software entities to be installed on the processing device, the instructions stored in the web page in a first language and including at least some server tags of the library of hierarchically-related tags implemented in the conversion services, the conversion services portion converting the web page in the first language into a second web page that is in a second language and providing the second web page in the second language to the requesting client as the requested web page.

24. The server system of claim 22, wherein the hierarchically-related tags of the library of hierarchically-related tags comprise a tag structure such that, for a web page that is coded within one of a first programming environment and a second programming environment and that includes at least some of the library of hierarchically-related tags, when that web page is run within the first programming environment or the second programming environment the hierarchically-related tags included in that web page behave identically.

25. The server system of claim 8, further comprising a mobile device interface, wherein, when the requesting client is executing on a mobile device, the mobile device having a display device having at least one display limitation, the mobile device interface receives at least one of the raster image data and the feature vector data output to the client, modifies attributes of at least one of the recieved raster image data and of at least one object within the received feature vector data based on the at least one display limitation of the mobile device, and outputs the modified at least one of the received raster image data and the recieved feature vector data in place of the received raster image data and the received feature vector data that was recieved by the mobile device interface.

26. A server system that receives data requests from a plurality of clients and that asynchronously streams requested data to the plurality of clients, at least first and second ones of the clients receiving a first portion of data, comprising:
a raster data services portion that, in response to image data requests that include requests for raster image data, streams the requested raster image data in a first predetermined format to the requesting client, and
a feature data services portion that, in response to image data requests that include requests for feature image data, streams feature vector image data in a second predetermined format to the requesting client as the requested feature image data; and
a collaboration services portion that receives collaboration data from a first client relative to the first portion of data, the collaboration services asynchronously forwarding the collaboration data received from the first client to at least the second client.
